(19) United States
(12) Patent Application Publication
(10) Pub. No.: US 2026/0186250 A1
(43) Pub. Date: Jul. 2, 2026

(54) OPTICAL LENS ASSEMBLY

(71) Applicant: GENIUS ELECTRONIC OPTICAL (XIAMEN) CO., LTD., Xiamen (CN)

(72) Inventors: Jia-Sin Jhang, Xiamen (CN); Shiyu Wu, Xiamen (CN); Feng Chen, Xiamen (CN)

(73) Assignee: GENIUS ELECTRONIC OPTICAL (XIAMEN) CO., LTD., Xiamen (CN)

(21) Appl. No.: 19/224,912

(22) Filed: Jun. 2, 2025

(30) Foreign Application Priority Data
Dec. 31, 2024 (CN) 202411977850.7

(51) Int. Cl. G02B 13/00; G02B 9/62

(52) U.S. Cl. CPC G02B 13/0045; G02B 9/62

(57) ABSTRACT

An optical lens assembly sequentially includes first to sixth lens elements along an optical axis from a light output side to a light input side. An optical axis region and a periphery region of a light input surface of the sixth lens element are concave and convex surfaces. A periphery region of a light output surface of the sixth lens element is a concave surface. The optical lens assembly satisfies EDmax/EDmin≤2.100 and 3.000≤(D21t32+G56)/D11t21. EDmax and EDmin are maximum and minimum values of effective diameters. D21t32 is a distance from a light output surface of the second lens element to a light input surface of the third lens element. G56 is an air gap between the fifth and sixth lens elements on the optical axis. D11t21 is a distance from a light output surface of the first lens element to the light output surface of the second lens element.

### CROSS-REFERENCE TO RELATED APPLICATION

This application claims the priority benefit of China application serial no. 202411977850.7, filed on Dec. 31, 2024. The entirety of the above-mentioned patent application is hereby incorporated by reference herein and made a part of this specification.

### BACKGROUND OF THE INVENTION

### 1. Field of the Invention

The invention relates to an optical lens assembly.

### 2. Description of Related Art

The specifications of a portable electronic device are changing quickly, and a key component, namely an optical imaging lens element, has also evolved to become more diversified. With the trends in virtual reality (VR) and/or augmented reality (AR) driving the accelerated development of head-mounted wearable devices and peripheral devices, optical lens element assemblies can now be used not only for photography and videography but also to utilize optical reflection principles for projecting information or images onto the lens elements of head-mounted wearable devices. Through reflection, the information or images can be projected into users' eyes, achieving an AR effect.

However, achieving the optimal balance between light convergence and projection imaging for a projection lens element while simultaneously maintaining a compact, lightweight, and thin optical lens assembly with excellent optical quality has become a significant challenge for industry designers.

### SUMMARY OF THE INVENTION

The invention provides an optical lens assembly that is conducive to enhancing projection effects, shortening a system length of a projection lens element, and/or providing good imaging quality.

An embodiment of the invention provides an optical lens assembly adapted to a projection lens element, where a plurality of light emitted from a multi-light source generating unit generate a plurality of light beams by the optical lens assembly. A direction towards the multi-light source generating unit is a light input side, and an opposite side of the light input side is a light output side. The optical lens assembly includes a first lens element, a second lens element, a third lens element, a fourth lens element, a fifth lens element, and a sixth lens element sequentially from the light output side to the light input side along an optical axis. Each of the first lens element, the second lens element, the third lens element, the fourth lens element, the fifth lens element, and the sixth lens element includes a light output surface facing the light output side and a light input surface facing the light input side. The fifth lens element has positive refracting power. An optical axis region of the light input surface of the sixth lens element is concave, and a periphery region of the light input surface of the sixth lens element is convex. A periphery region of the light output surface of the sixth lens element is concave. The optical lens assembly consists of the aforementioned first lens element to sixth lens element and satisfies following conditional expressions: EDmax/EDmin≤2.100 and 3.000≤(D21t32+G56)/D11t21, where EDmax is the maximum value of effective diameters of the first lens element to the sixth lens element, EDmin is the minimum value of the effective diameters of the first lens element to the sixth lens element, D21t32 is a distance from the light output surface of the second lens element to the light input surface of the third lens element, G56 is an air gap between the fifth lens element and the sixth lens element on the optical axis, and D11t21 is a distance from the light output surface of the first lens element to the light output surface of the second lens element.

An embodiment of the invention provides an optical lens assembly adapted to a projection lens element, where a plurality of light emitted from a multi-light source generating unit generate a plurality of light beams by the optical lens assembly. A direction towards the multi-light source generating unit is a light input side, and an opposite side of the light input side is a light output side. The optical lens assembly includes a first lens element, a second lens element, a third lens element, a fourth lens element, a fifth lens element, and a sixth lens element sequentially from the light output side to the light input side along an optical axis. Each of the first lens element, the second lens element, the third lens element, the fourth lens element, the fifth lens element, and the sixth lens element includes a light output surface facing the light output side and a light input surface facing the light input side. The fifth lens element has positive refracting power. An optical axis region of the light output surface of the second lens element is convex. An optical axis region of the light input surface of the sixth lens element is concave. A periphery region of the light output surface of the sixth lens element is concave. The optical lens assembly consists of the aforementioned first lens element to sixth lens element and satisfies following conditional expressions: EDmax/EDmin≤2.100 and 4.100≤(D21t32+G56)*Fno/(D11t21+G34), where EDmax is the maximum value of effective diameters of the first lens element to the sixth lens element, EDmin is the minimum value of the effective diameters of the first lens element to the sixth lens element, D21t32 is a distance from the light output surface of the second lens element to the light input surface of the third lens element, G56 is an air gap between the fifth lens element and the sixth lens element on the optical axis, Fno is an F-number, D11t21 is a distance from the light output surface of the first lens element to the light output surface of the second lens element, and G34 is an air gap between the third lens element and the fourth lens element on the optical axis.

An embodiment of the invention provides an optical lens assembly adapted to a projection lens element, wherein a plurality of light emitted from a multi-light source generating unit generate a plurality of light beams by the optical lens assembly. A direction towards the multi-light source generating unit is a light input side, and an opposite side of the light input side is a light output side. The optical lens assembly includes a first lens element, a second lens element, a third lens element, a fourth lens element, a fifth lens element, and a sixth lens element sequentially from the light output side to the light input side along an optical axis. Each of the first lens element, the second lens element, the third lens element, the fourth lens element, the fifth lens element, and the sixth lens element includes a light output surface facing the light output side and a light input surface facing the light input side. The fifth lens element has positive refracting power. A periphery region of the light output surface of the fifth lens element is concave. An optical axis region of the light input surface of the sixth lens element is concave. A periphery region of the light output surface of the sixth lens element is concave. The optical lens assembly consists of the aforementioned first lens element to sixth lens element and satisfies following conditional expressions: EDmax/EDmin≤2.100 and 4.100≤(D21t32+G56)*Fno/(D11t21+G34), where EDmax is the maximum value of effective diameters of the first lens element to the sixth lens element, EDmin is the minimum value of the effective diameters of the first lens element to the sixth lens element, D21t32 is a distance from the light output surface of the second lens element to the light input surface of the third lens element, G56 is an air gap between the fifth lens element and the sixth lens element on the optical axis, Fno is an F-number, D11t21 is a distance from the light output surface of the first lens element to the light output surface of the second lens element, and G34 is an air gap between the third lens element and the fourth lens element on the optical axis.

Based on the above, some beneficial effects of the optical imaging lens element provided in one or more embodiments of the invention include: by satisfying the aforementioned concave and convex surface arrangement design of the lens elements, the refracting power conditions, and the design satisfying the above conditional expressions, the optical lens assembly can contribute to enhancing the projection effect, shortening the system length of the projection lens element, and/or providing good imaging quality.

To make the above-mentioned features and advantages of the invention more comprehensible, embodiments are described in detail below with reference to the accompanying drawings.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A is a schematic diagram illustrating that an optical lens assembly of the invention is applied to a projection lens element.

FIG. 1B is a front view of a multi-light source generating unit depicted in FIG. 1A according to an embodiment of the invention.

FIG. 2 is a schematic diagram illustrating a surface profile structure of a lens element.

FIG. 3 is a schematic diagram illustrating a concave-convex surface profile structure and a focal point of rays of a lens element.

FIG. 4 is a schematic diagram illustrating a surface profile structure of a lens element in Example 1.

FIG. 5 is a schematic diagram illustrating a surface profile structure of a lens element in Example 2.

FIG. 6 is a schematic diagram illustrating a surface profile structure of a lens element in Example 3.

FIG. 7 is a schematic diagram of an optical lens assembly according to a first embodiment of the invention.

FIG. 8A to FIG. 8D are diagrams showing longitudinal spherical aberrations and various aberrations of the optical lens assembly according to the first embodiment of the invention.

FIG. 9 illustrates detailed optical data of the optical lens assembly according to the first embodiment of the invention.

FIG. 10 illustrates aspheric parameters of the optical lens assembly according to the first embodiment of the invention.

FIG. 11 is a schematic diagram of an optical lens assembly according to a second embodiment of the invention.

FIG. 12A to FIG. 12D are diagrams showing longitudinal spherical aberrations and various aberrations of the optical lens assembly according to the second embodiment of the invention.

FIG. 13 illustrates detailed optical data of the optical lens assembly according to the second embodiment of the invention.

FIG. 14 illustrates aspheric parameters of the optical lens assembly according to the second embodiment of the invention.

FIG. 15 is a schematic diagram of an optical lens assembly according to a third embodiment of the invention.

FIG. 16A to FIG. 16D are diagrams showing longitudinal spherical aberrations and various aberrations of the optical lens assembly according to the third embodiment of the invention.

FIG. 17 illustrates detailed optical data of the optical lens assembly according to the third embodiment of the invention.

FIG. 18 illustrates aspheric parameters of the optical lens assembly according to the third embodiment of the invention.

FIG. 19 is a schematic diagram of an optical lens assembly according to a fourth embodiment of the invention.

FIG. 20A to FIG. 20D are diagrams showing longitudinal spherical aberrations and various aberrations of the optical lens assembly according to the fourth embodiment of the invention.

FIG. 21 illustrates detailed optical data of the optical lens assembly according to the fourth embodiment of the invention.

FIG. 22 illustrates aspheric parameters of the optical lens assembly according to the fourth embodiment of the invention.

FIG. 23 is a schematic diagram of an optical lens assembly according to a fifth embodiment of the invention.

FIG. 24A to FIG. 24D are diagrams showing longitudinal spherical aberrations and various aberrations of the optical lens assembly according to the fifth embodiment of the invention.

FIG. 25 illustrates detailed optical data of the optical lens assembly according to the fifth embodiment of the invention.

FIG. 26 illustrates aspheric parameters of the optical lens assembly according to the fifth embodiment of the invention.

FIG. 27 is a schematic diagram of an optical lens assembly according to a sixth embodiment of the invention.

FIG. 28A to FIG. 28D are diagrams showing longitudinal spherical aberrations and various aberrations of the optical lens assembly according to the sixth embodiment of the invention.

FIG. 29 illustrates detailed optical data of the optical lens assembly according to the sixth embodiment of the invention.

FIG. 30 illustrates aspheric parameters of the optical lens assembly according to the sixth embodiment of the invention.

FIG. 31 is a schematic diagram of an optical lens assembly according to a seventh embodiment of the invention.

FIG. 32A to FIG. 32D are diagrams showing longitudinal spherical aberrations and various aberrations of the optical lens assembly according to the seventh embodiment of the invention.

FIG. 33 illustrates detailed optical data of the optical lens assembly according to the seventh embodiment of the invention.

FIG. 34 illustrates aspheric parameters of the optical lens assembly according to the seventh embodiment of the invention.

FIG. 35 is a schematic diagram of an optical lens assembly according to an eighth embodiment of the invention.

FIG. 36A to FIG. 36D are diagrams showing longitudinal spherical aberrations and various aberrations of the optical lens assembly according to the eighth embodiment of the invention.

FIG. 37 illustrates detailed optical data of the optical lens assembly according to the eighth embodiment of the invention.

FIG. 38 illustrates aspheric parameters of the optical lens assembly according to the eighth embodiment of the invention.

FIG. 39 is a schematic diagram of an optical lens assembly according to a ninth embodiment of the invention.

FIG. 40A to FIG. 40D are diagrams showing longitudinal spherical aberrations and various aberrations of the optical lens assembly according to the ninth embodiment of the invention.

FIG. 41 illustrates the detailed optical data of the optical lens assembly according to the ninth embodiment of the invention.

FIG. 42 illustrates the aspheric parameters of the optical lens assembly according to the ninth embodiment of the invention.

FIG. 43 to FIG. 46 illustrate all important parameters and numerical values of relational expressions for the optical lens element assemblies according to the first to ninth embodiments of the invention.

### DESCRIPTION OF THE EMBODIMENTS

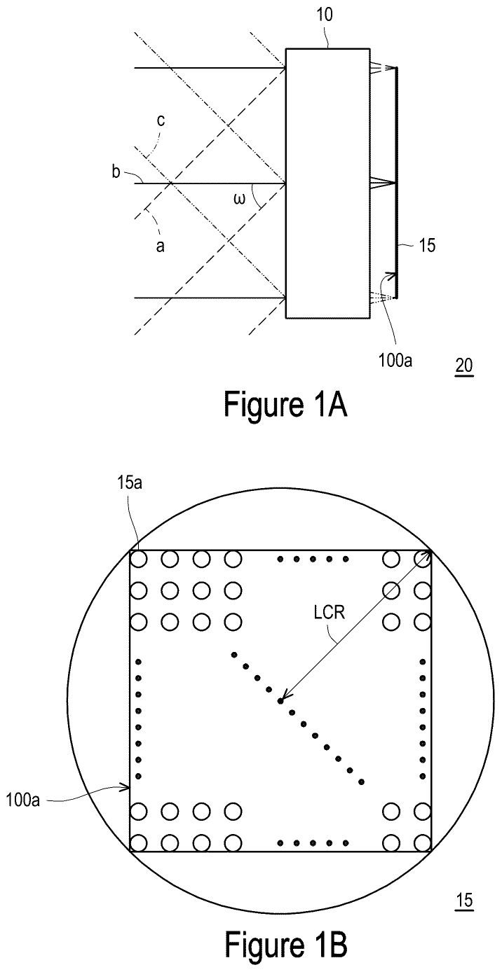

With reference to FIG. 1A, a ray direction of a projection lens element 20 is display light or sensing light emitted from a multi-light source generating unit 15, and the light passes through an optical lens assembly 10 provided in one or more embodiments of the invention to generate a plurality of light beams a, b, and c for detecting the environment in front of the projection lens element 20. The light beams a, b, and c are not limited to any specific form of light beam and are described here in the form of dashed lines to indicate the direction of light beam propagation. The number of the light beams a, b, and c is also not limited to three and can be any number other than 3 and 1. In FIG. 1A, the light beams a, b, and c are shown as representatives. Referring to FIG. 1B, in one embodiment, the multi-light source generating unit 15 includes a plurality of light sources 15a arranged in an array. In other embodiments, these light sources 15a can also be arranged in a circular pattern or in any other manner, which should however not be construed as a limitation in the invention. The light sources 15a can be display light sources for projecting the display light. Light emitting surfaces of these light sources 15a form a light emitting surface 100a of the multi-light source generating unit 15.

In the following descriptions, the criteria for determining the optical specifications provided in one or more embodiments of the invention assume that the light direction is reversely tracked as a parallel ray passing through the optical lens assembly 10 from a light output side to focus and form an image on the light emitting surface 100a of the multi-light source generating unit 15.

The terms “optical axis region”, “periphery region”, “concave”, and “convex” used in this specification and claims should be interpreted based on the definition listed in the specification by the principle of lexicographer.

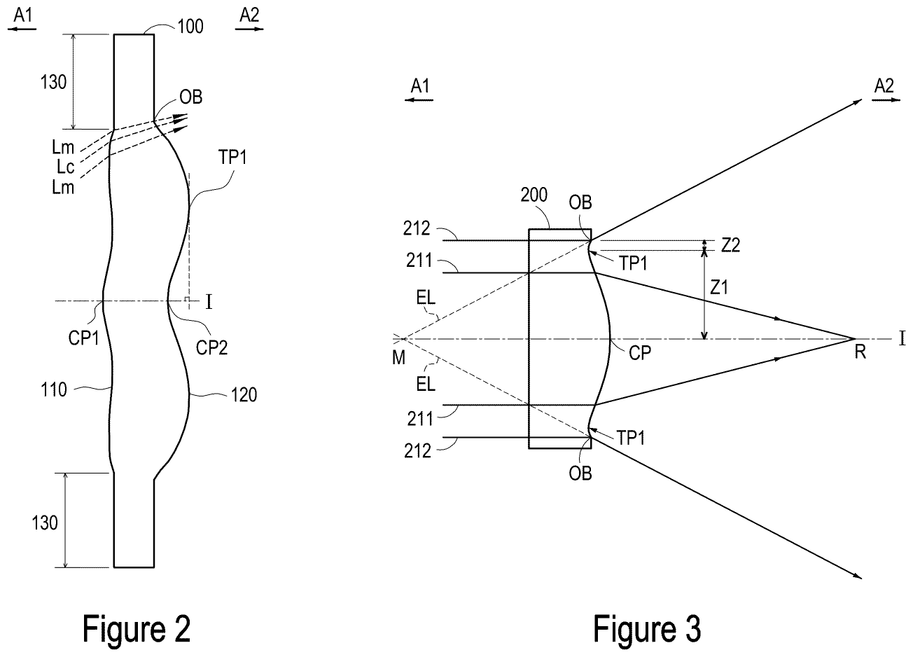

In the present disclosure, the optical lens assembly 10 may comprise at least one lens element to receive rays that are incident on the optical system over a set of angles ranging from parallel to an optical axis to a half field of view (HFOV) angle with respect to the optical axis. The term “a lens element having positive refracting power (or negative refracting power)” means that the paraxial refracting power of the lens element in Gaussian optics is positive (or negative). The term “a light output surface (or a light input surface) of a lens element” refers to a specific region of that surface of the lens element at which rays can pass through that specific region. Rays include at least two types of rays: a chief ray Lc and a marginal ray Lm (as shown in FIG. 2). A light output surface (or a light input surface) of a lens element may be characterized as having several regions, including an optical axis region, a periphery region, and, in some cases, one or more intermediate regions, according to different locations, and the regions will be discussed more fully below.

FIG. 2 is a radial cross-sectional view of a lens element 100. Two referential points for surfaces of the lens element 100 can be defined as a central point and a transition point. The central point of a surface of a lens element is a point of intersection of that surface and the optical axis I. As illustrated in FIG. 2, a first central point CP1 may be present on the light output surface 110 of lens element 100 and a second central point CP2 may be present on the light input surface 120 of the lens element 100. The transition point is a point on a surface of a lens element, at which the line tangent to that point is perpendicular to the optical axis I. The optical boundary OB of a surface of the lens element is defined as a point at which the radially outermost marginal ray Lm passing through the surface of the lens element intersects the surface of the lens element. All transition points lie between the optical axis I and the optical boundary OB of the surface of the lens element. A surface of the lens element 100 may have no transition point or have at least one transition point. If multiple transition points are present on a single surface, then these transition points are sequentially named along the radial direction of the surface with reference numerals starting from the first transition point. For example, the first transition point, e.g., TP1, (closest to the optical axis I), the second transition point, e.g., TP2, (as shown in FIG. 5), and the Nth transition point (farthest from the optical axis I).

When a surface of the lens element has at least one transition point, the region of the surface of the lens element from the central point to the first transition point TP1 is defined as the optical axis region, which includes the central point. The region located radially outside of the farthest transition point (the Nth transition point) from the optical axis I to the optical boundary OB of the surface of the lens element is defined as the periphery region. In some embodiments, there may be intermediate regions present between the optical axis region and the periphery region, with the number of intermediate regions depending on the number of the transition points. When a surface of the lens element has no transition point, the optical axis region is defined as a region of 0%-50% of the distance between the optical axis I and the optical boundary OB of the surface of the lens element, and the periphery region is defined as a region of 50%-100% of the distance between the optical axis I and the optical boundary OB of the surface of the lens element.

The shape of a region is convex if a collimated ray being parallel to the optical axis I and passing through the region is bent toward the optical axis I such that the ray intersects the optical axis I on the light input side A2 of the lens element. The shape of a region is concave if the extension line of a collimated ray being parallel to the optical axis I and passing through the region intersects the optical axis I on the light output side A1 of the lens element.

Additionally, referring to FIG. 2, the lens element 100 may also have a mounting portion 130 extending radially outward from the optical boundary OB. The mounting portion 130 is typically used to physically secure the lens element to a corresponding element of the optical lens assembly 10 (not shown). Rays do not reach the mounting portion 130. The structure and shape of the mounting portion 130 are only examples to explain the technologies, and should not be taken as limiting the scope of the present disclosure. The mounting portion 130 of the lens elements discussed below may be partially or completely omitted in the following drawings.

Referring to FIG. 3, an optical axis region Z1 is defined between central point CP and first transition point TP1. Periphery region Z2 is defined between TP1 and the optical boundary OB of the surface of the lens element. Collimated ray 211 intersects the optical axis I on the light input side A2 of lens element 200 after passing through optical axis region Z1, i.e., the focal point of collimated ray 211 after passing through optical axis region Z1 is on the light input side A2 of the lens element 200 at point R in FIG. 3. Accordingly, since the ray itself intersects the optical axis I on the light input side A2 of the lens element 200, optical axis region Z1 is convex. On the contrary, collimated ray 212 diverges after passing through periphery region Z2. The extension line EL of collimated ray 212 after passing through periphery region Z2 intersects the optical axis I on the light output side A1 of lens element 200, i.e., the focal point of collimated ray 212 after passing through periphery region Z2 is on the light output side A1 at point M in FIG. 3. Accordingly, since the extension line EL of the ray intersects the optical axis I on the light output side A1 of the lens element 200, periphery region Z2 is concave. In the lens element 200 illustrated in FIG. 3, the first transition point TP1 is the border of the optical axis region and the periphery region, i.e., TP1 is the point at which the shape changes from convex to concave.

Alternatively, there is another way for a person having ordinary skill in the art to determine whether an optical axis region is convex or concave by referring to the sign of “Radius of curvature” (the “R” value), which is the paraxial radius of shape of a lens element surface in the optical axis region. The R value is commonly used in conventional optical design software such as Zemax and CodeV. The R value usually appears in the lens element data sheet in the software. For a light output surface, a positive R value defines that the optical axis region of the light output surface is convex, and a negative R value defines that the optical axis region of the light output surface is concave. Conversely, for a light input surface, a positive R value defines that the optical axis region of the light input surface is concave, and a negative R value defines that the optical axis region of the light input surface is convex. The result found by using this method should be consistent with the method utilizing intersection of the optical axis by rays/extension lines mentioned above, which determines surface shape by referring to whether the focal point of a collimated ray being parallel to the optical axis I is on the light output side or the light input side of a lens element. As used herein, the terms “a shape of a region is convex (concave),” “a region is convex (concave),” and “a convex-(concave-) region,” may be used alternatively.

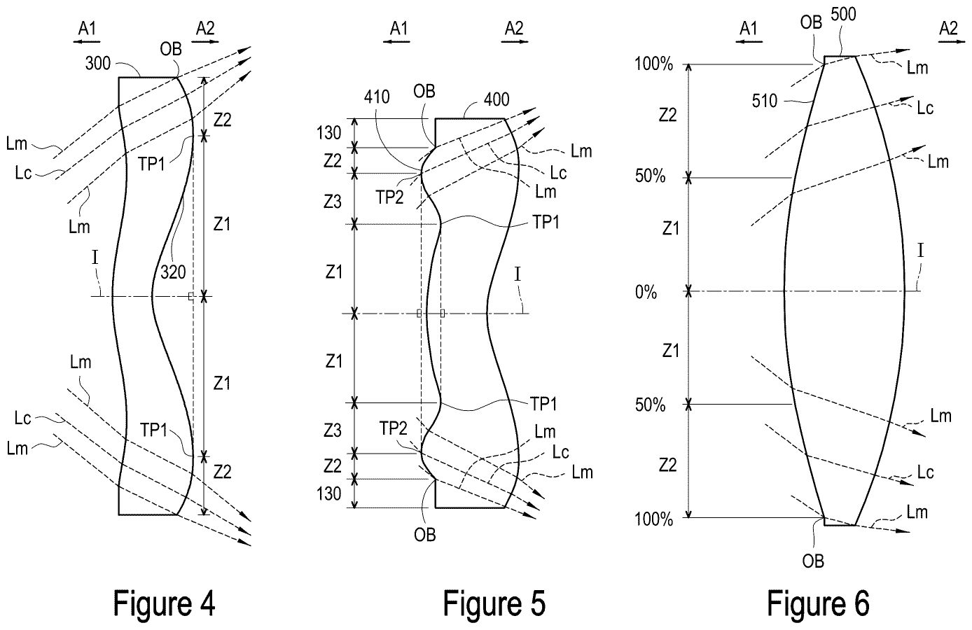

FIG. 4, FIG. 5, and FIG. 6 illustrate examples of determining the shape of lens element regions and the boundaries of regions under various circumstances, including the optical axis region, the periphery region, and intermediate regions as set forth in the present specification.

FIG. 4 is a radial cross-sectional view of a lens element 300. As illustrated in FIG. 4, only one transition point TP1 appears within the optical boundary OB of the light input surface 320 of the lens element 300. The optical axis region Z1 and periphery region Z2 of the light input surface 320 of the lens element 300 are illustrated in FIG. 4. The R value of the light input surface 320 is positive (i.e., R>0). Accordingly, the optical axis region Z1 is concave.

In general, the shape of each region demarcated by the transition point will have an opposite shape to the shape of the adjacent region(s). Accordingly, the transition point will define a transition in shape, changing from concave to convex at the transition point or changing from convex to concave. In FIG. 4, since the shape of the optical axis region Z1 is concave, the shape of the periphery region Z2 will be convex as the shape changes at the transition point TP1.

FIG. 5 is a radial cross-sectional view of a lens element 400. Referring to FIG. 5, a first transition point TP1 and a second transition point TP2 are present on the light output surface 410 of lens element 400. The optical axis region Z1 of the light output surface 410 is defined between the optical axis I and the first transition point TP1. The R value of the light output surface 410 is positive (i.e., R>0). Accordingly, the optical axis region Z1 is convex.

The periphery region Z2 of the light output surface 410, which is also convex, is defined between the second transition point TP2 and the optical boundary OB of the light output surface 410 of the lens element 400. Further, intermediate region Z3 of the light output surface 410, which is concave, is defined between the first transition point TP1 and the second transition point TP2. Referring once again to FIG. 5, the light output surface 410 includes an optical axis region Z1 located between the optical axis I and the first transition point TP1, an intermediate region Z3 located between the first transition point TP1 and the second transition point TP2, and a periphery region Z2 located between the second transition point TP2 and the optical boundary OB of the light output surface 410 of the lens element 400. Since the shape of the optical axis region Z1 is designed to be convex, the shape of the intermediate region Z3 is concave as the shape of the intermediate region Z3 changes at the first transition point TP1, and the shape of the periphery region Z2 is convex as the shape of the periphery region Z2 changes at the second transition point TP2.

FIG. 6 is a radial cross-sectional view of a lens element 500. The lens element 500 has no transition point on the light output surface 510 of the lens element 500. For a surface of a lens element with no transition point, for example, the light output surface 510 the lens element 500, the optical axis region Z1 is defined as the region of 0%-50% of the distance between the optical axis I and the optical boundary OB of the surface of the lens element and the periphery region is defined as the region of 50%-100% of the distance between the optical axis I and the optical boundary OB of the surface of the lens element. Referring to lens element 500 illustrated in FIG. 6, the optical axis region Z1 of the light output surface 510 is defined between the optical axis I and 50% of the distance between the optical axis I and the optical boundary OB. The R value of the light output surface 510 is positive (i.e., R>0). Accordingly, the optical axis region Z1 is convex. For the light output surface 510 of the lens element 500, because there is no transition point, the periphery region Z2 of the light output surface 510 is also convex. It should be noted that lens element 500 may have a mounting portion (not shown) extending radially outward from the periphery region Z2.

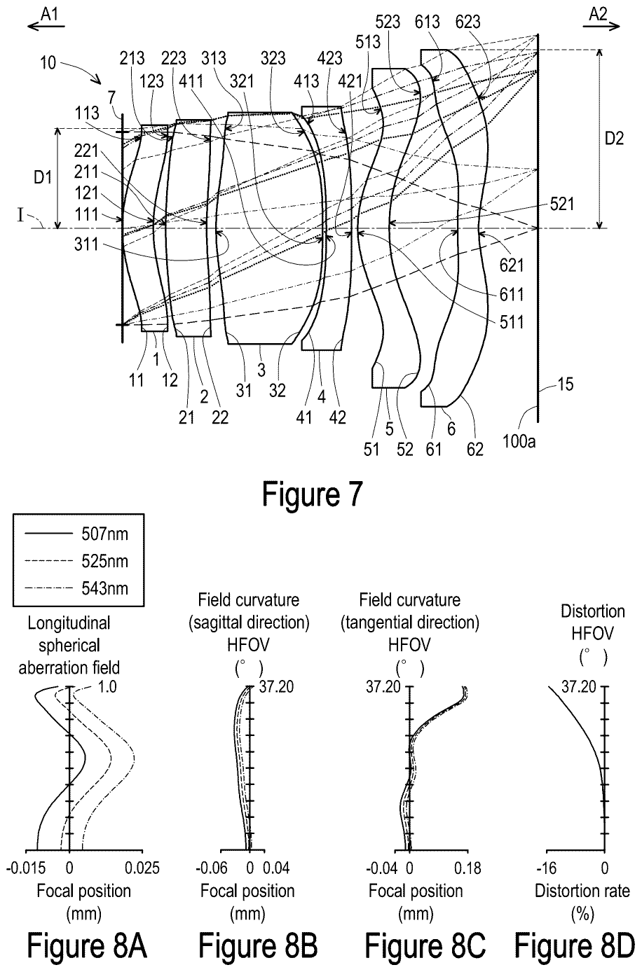

FIG. 7 is a schematic view of an optical lens assembly according to a first embodiment of the invention. FIG. 8A to FIG. 8D are diagrams of longitudinal spherical aberrations and various aberrations of the optical lens assembly according to the first embodiment. With reference to FIG. 7 first, the optical lens assembly 10 provided in the first embodiment of the invention is applicable to a projection lens element. The optical lens assembly 10 sequentially includes an aperture 7, a first lens element 1, a second lens element 2, a third lens element 3, a fourth lens element 4, a fifth lens element 5, and a sixth lens element 6 along an optical axis I from a light output side A1 to a light input side A2. When the light emitting surface 100a of the multi-light source generating unit 15 emits light which enters the optical lens assembly 10, the light sequentially passes through the sixth lens element 6, the fifth lens element 5, the fourth lens element 4, the third lens element 3, the second lens element 2, the first lens element 1, and the aperture 7 to generate a plurality of light beams, which are then emitted from the optical lens assembly 10. It is to be noted that the light input side A2 is a side facing the multi-light source generating unit 15, while an opposite side of the light input side A2 is the light output side A1. It is worth mentioning that in the optical lens assembly 10, there are six lens elements with refracting power, namely the first lens element 1, the second lens element 2, the third lens element 3, the fourth lens element 4, the fifth lens element 5, and the sixth lens element 6, and materials of the first lens element 1, the second lens element 2, the third lens element 3, the fourth lens element 4, the fifth lens element 5, and the sixth lens element 6 can include plastic or glass.

In this embodiment, each of the first lens element 1, the second lens element 2, the third lens element 3, the fourth lens element 4, the fifth lens element 5, and the sixth lens element 6 of the optical lens assembly 10 includes a light output surface 11, 21, 31, 41, 51, and 61 facing the light output side A1 and a light input surface 12, 22, 32, 42, 52, and 62 facing the light input side A2.

The first lens element 1 has positive refracting power. The material of the first lens element 1 is plastic (for instance, EP-9000_21). An optical axis region 111 of the light output surface 11 of the first lens element 1 is convex, and a periphery region 113 of the light output surface 11 of the first lens element 1 is convex. An optical axis region 121 of the light input surface 12 of the first lens element 1 is concave, and a periphery region 123 of the light input surface 12 of the first lens element 1 is concave. In this embodiment, both the light output surface 11 and the light input surface 12 of the first lens element 1 are aspheric surfaces, which should however not be construed as a limitation herein.

The second lens element 2 has positive refracting power. The material of the second lens element 2 is glass (for instance, M-TAF101). An optical axis region 211 of the light output surface 21 of the second lens element 2 is convex, and a periphery region 213 of the light output surface 21 of the second lens element 2 is convex. An optical axis region 221 of the light input surface 22 of the second lens element 2 is concave, and a periphery region 223 of the light input surface 22 of the second lens element 2 is concave. In this embodiment, both the light output surface 21 and the light input surface 22 of the second lens element 2 are aspheric surfaces, which should however not be construed as a limitation herein.

The third lens element 3 has positive refracting power. The material of the third lens element 3 is plastic (for instance, APL5014CL). An optical axis region 311 of the light output surface 31 of the third lens element 3 is convex, and the periphery region 313 of the light output surface 31 of the third lens element 3 is convex. An optical axis region 321 of the light input surface 32 of the third lens element 3 is convex, and a periphery region 323 of the light input surface 32 of the third lens element 3 is convex. In this embodiment, both the light output surface 31 and the light input surface 32 of the third lens element 3 are aspheric surfaces, which should however not be construed as a limitation herein.

The fourth lens element 4 has negative refracting power. The material of the fourth lens element 4 is plastic (for instance, EP-8000_21). An optical axis region 411 of the light output surface 41 of the fourth lens element 4 is concave, and a periphery region 413 of the light output surface 41 of the fourth lens element 4 is concave. An optical axis region 421 of the light input surface 42 of the fourth lens element 4 is concave, and a periphery region 423 of the light input surface 42 of the fourth lens element 4 is convex. In this embodiment, both the light output surface 41 and the light input surface 42 of the fourth lens element 4 are aspheric surfaces, which should however not be construed as a limitation herein.

The fifth lens element 5 has positive refracting power. The material of the fifth lens element 5 is plastic (for instance, APL5014CL). An optical axis region 511 of the light output surface 51 of the fifth lens element 5 is convex, and a periphery region 513 of the light output surface 51 of the fifth lens element 5 is concave. An optical axis region 521 of the light input surface 52 of the fifth lens element 5 is concave, and a periphery region 523 of the light input surface 52 of the fifth lens element 5 is convex. In this embodiment, both the light output surface 51 and the light input surface 52 of the fifth lens element 5 are aspheric surfaces, which should however not be construed as a limitation herein.

The sixth lens element 6 has negative refracting power. The material of the sixth lens element 6 is plastic (for instance, ZEONEX-K26R_17). An optical axis region 611 of the light output surface 61 of the sixth lens element 6 is convex, and a periphery region 613 of the light output surface 61 of the sixth lens element 6 is concave. An optical axis region 621 of the light input surface 62 of the sixth lens element 6 is concave, and a periphery region 623 of the light input surface 62 of the sixth lens element 6 is convex. In this embodiment, both the light output surface 61 and the light input surface 62 of the sixth lens element 6 are aspheric surfaces, which should however not be construed as a limitation herein.

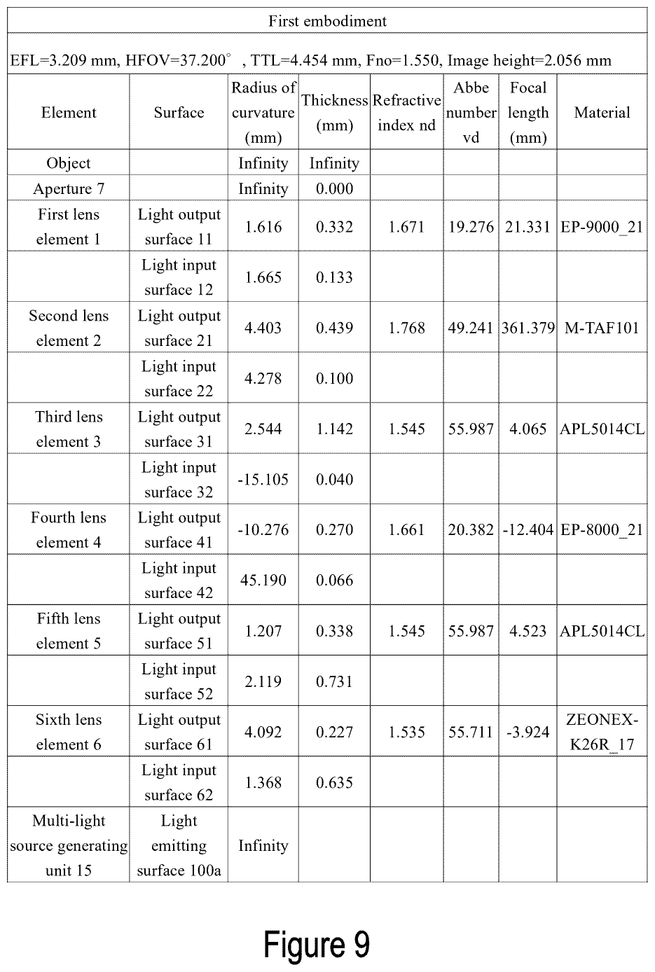

Other detailed optical data provided in the first embodiment are shown in FIG. 9, and an effective focal length (EFL) of the optical lens assembly 10 provided in the first embodiment is 3.209 millimeters (mm), a half field of view (HFOV) is 37.200°, a system length (TTL) is 4.454 mm, an F-number (Fno) is 1.550, and an image height is 2.056 mm, where the system length refers to a distance along an optical axis I from the light output surface 11 of the first lens element 1 to the light emitting surface 100a. The “F-number” in this specification is calculated by considering the aperture 7 as the entrance pupil based on the principle of light reversibility.

In this embodiment, the light output surfaces 11, 21, 31, 41, 51, and 61 and the light input surfaces 12, 22, 32, 42, 52, and 62 of the first lens element 1, the second lens element 2, the third lens element 3, the fourth lens element 4, the fifth lens element 5, and the sixth lens element 6, totaling twelve surfaces, are all aspheric surfaces, where the light output surfaces 11, 21, 31, 41, 51, and 61 and the light input surfaces 12, 22, 32, 42, 52, and 62 are normal even aspheric surfaces. These aspheric surfaces are defined according to a formula (1):

$$Z ( Y ) = \frac{{Y}^{2}}{R} / ( 1 + \sqrt{1 - ( 1 + K ) \frac{{Y}^{2}}{{R}^{2}}} ) + {{\sum }_{i = 1}}^{π} {a}_{i} \times {Y}^{i} \qquad ( 1 )$$

where
Y: a distance between a point on an aspheric curve and the optical axis I;
Z: a depth of an aspheric surface (a perpendicular distance between a point on the aspheric surface at a distance Y from the optical axis I and a tangent plane tangent to a vertex of the aspheric surface on the optical axis I);
R: a radius of curvature of a surface of the lens element near the optical axis I;
K: a conic constant;
aᵢ: an ith order aspheric coefficient.

Material parameters of the lens elements disclosed in an optical parameter table provided in one or more embodiments of the invention are presented using the international glass code format for the refractive index (nd) and the Abbe number (Vd), so as to enable individuals skilled in the art to understand the specific material implementations. Here, nd refers to the refractive index of the material at the d-line of helium yellow light at 587.56 nm, while Vd is calculated using the refractive indices of the material at the d, F, and C wavelengths of the Fraunhofer spectrum.

Focal length values disclosed in the optical parameter table provided in one or more embodiments are calculated using the refractive indices of the optical system implemented at the wavelength band. The primary wavelength implemented in one or more embodiments of the invention is 525 nm. Therefore, the focal length values of the invention are calculated using the refractive indices of the materials at 525 nm.

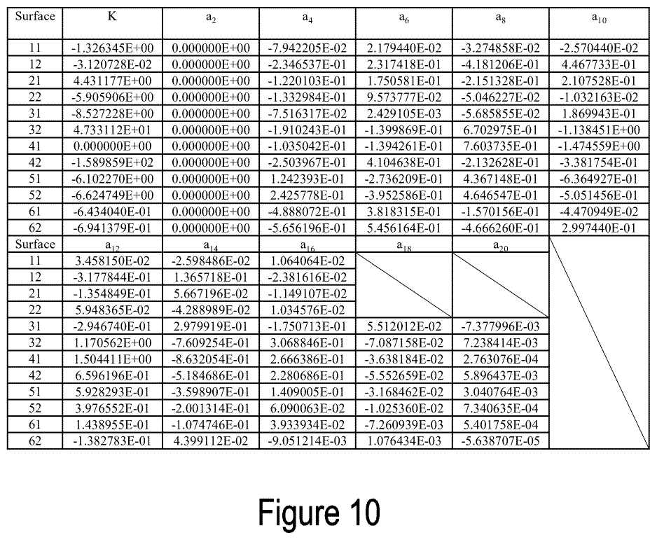

Aspheric coefficients for each item in the formula (1) from the light output surface 11 of the first lens element 1 to the light input surface 62 of the sixth lens element 6 are shown in FIG. 10. In FIG. 10, column number 11 indicates that it represents the aspheric coefficients of the light output surface 11 of the first lens element 1, and other columns follow the same pattern.

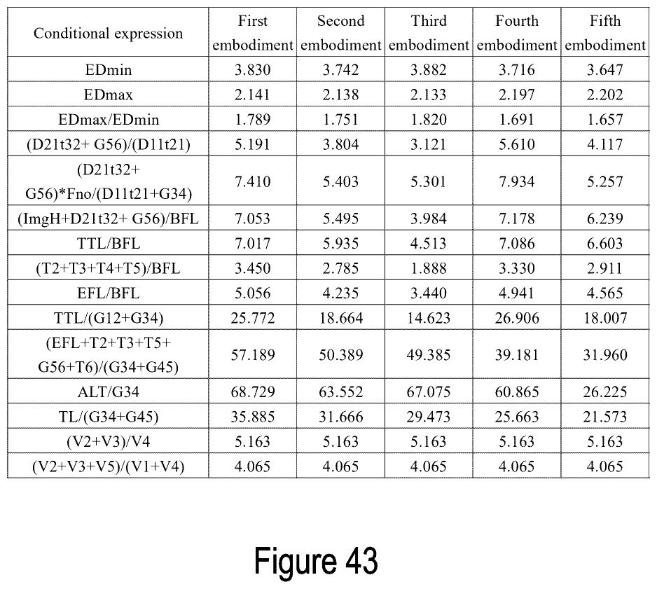

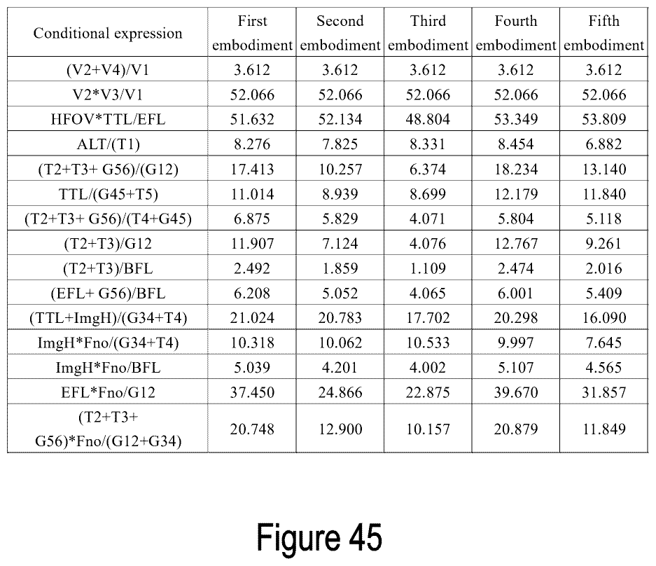

In addition, relations among all important parameters in the optical lens assembly 10 provided in the first embodiment are shown in FIG. 43 and FIG. 45. In FIG. 43 to FIG. 46, the units of each parameter are in mm. In this disclosure, the parameters are defined as follows:
T1 is a thickness of the first lens element 1 on the optical axis I;
T2 is a thickness of the second lens element 2 on the optical axis I;
T3 is a thickness of the third lens element 3 on the optical axis I;
T4 is a thickness of the fourth lens element 4 on the optical axis I;
T5 is a thickness of the fifth lens element 5 on the optical axis I;
T6 is a thickness of the sixth lens element 6 on the optical axis I;
G12 is an air gap between the first lens element 1 and the second lens element 2 on the optical axis I;
G23 is an air gap between the second lens element 2 and the third lens element 3 on the optical axis I;
G34 is an air gap between the third lens element 3 and the fourth lens element 4 on the optical axis I;
G45 is an air gap between the fourth lens element 4 and the fifth lens element 5 on the optical axis I;
G56 is an air gap between the fifth lens element 5 and the sixth lens element 6 on the optical axis I;
AAG is a sum of five air gaps from the first lens element 1 to the sixth lens element 6 on the optical axis I, i.e., a sum of G12, G23, G34, G45, and G56;
ALT is a sum of the thicknesses of the six lens elements from the first lens element 1 to the sixth lens element 6 on the optical axis I, i.e., a sum of T1, T2, T3, T4, T5, and T6;
D21t32 is a distance from the light output surface 21 of the second lens element 2 to the light input surface 32 of the third lens element 3, i.e., a sum of T2, G23 and T3;
D11t21 is a distance from the light output surface 11 of the first lens element 1 to the light output surface 21 of the second lens element 2, i.e., a sum of T1 and G12;
TL is a distance from the light output surface 11 of the first lens element 1 to the light input surface 62 of the sixth lens element 6 on the optical axis I;
TTL is a distance from the light output surface 11 of the first lens element 1 to the light emitting surface 100a on the optical axis I;
BFL is a distance from the light input surface 62 of the sixth lens element 6 to the light emitting surface 100a on the optical axis I;
LCR (light circle radius) is a radius of a light emitting circle (marked as LCR, as illustrated in FIG. 1B), which is a radius of the smallest circumscribed circle of the light emitting surface 100a of the multi-light source generating unit 15 and also the image height of the optical lens assembly 10;
HFOV is a half field of view (marked as ω, as illustrated in FIG. 1A), which is the maximum half light output angle of the optical lens assembly 10;
Fno is the F-number, which is calculated based on the effective aperture of the optical lens assembly 10 emitting parallel light according to the principle of light reversibility;
EFL is the effective focal length of the optical lens assembly 10.

Additionally, further definitions are:
G6P is an air gap from the light input surface 62 of the sixth lens element 6 to the light emitting surface 100a on the optical axis I;
f1 is a focal length of the first lens element 1;
f2 is a focal length of the second lens element 2;
f3 is a focal length of the third lens element 3;
f4 is a focal length of the fourth lens element 4;
f5 is a focal length of the fifth lens element 5;
f6 is a focal length of the sixth lens element 6;
n1 is the refractive index nd of the first lens element 1;
n2 is the refractive index nd of the second lens element 2;
n3 is the refractive index nd of the third lens element 3;
n4 is the refractive index nd of the fourth lens element 4;
n5 is the refractive index nd of the fifth lens element 5;
n6 is the refractive index nd of the sixth lens element 6;
V1 is the Abbe number Vd of the first lens element 1;
V2 is the Abbe number Vd of the second lens element 2;
V3 is the Abbe number Vd of the third lens element 3;
V4 is the Abbe number Vd of the fourth lens element 4;
V5 is the Abbe number Vd of the fifth lens element 5; and
V6 is the Abbe number Vd of the sixth lens element 6.

With further reference to FIG. 8A to FIG. 8D, FIG. 8A illustrates longitudinal spherical aberrations on the light emitting surface 100a provided in the first embodiment when its pupil radius is 1.0350 mm and when its wavelengths are 507 nm, 525 nm, and 543 nm. FIG. 8B and FIG. 8C illustrate field curvature aberrations in a sagittal direction and a tangential direction, respectively, on the light emitting surface 100a provided in the first embodiment when its wavelengths are 507 nm, 525 nm, and 543 nm. FIG. 8D illustrates distortion aberrations on the light emitting surface 100a provided in the first embodiment when its wavelengths are 507 nm, 525 nm, and 543 nm. In FIG. 8 which illustrates the longitudinal spherical aberrations, the curves formed by each wavelength are very close to each other and converge towards the center, indicating that off-axis rays of different heights for each wavelength are concentrated near the imaging point. From the deviation amplitude of each wavelength curve, it can be seen that the imaging point deviations of the off-axis rays of different heights are controlled within the range of ±0.025 mm. Therefore, according to the first embodiment, the spherical aberration of the same wavelength is indeed significantly improved. Moreover, the distances between the three representative wavelengths are also rather close, indicating that the imaging positions of rays of different wavelengths are highly concentrated, thus significantly improving chromatic aberrations as well.

In FIG. 8B and FIG. 8C, the two diagrams showing the field curvature aberrations, the focal length variation of the three representative wavelengths falls within +0.18 mm across the entire field of view, indicating that the optical lens assembly provided in the first embodiment can effectively eliminate aberrations. The distortion aberration diagram in FIG. 8D shows that the distortion aberrations provided in the first embodiment are maintained within the range of ±16%, indicating that the distortion aberrations provided in the first embodiment meet the imaging quality requirements of the optical lens assembly. This demonstrates that compared to the existing optical lens elements, good imaging quality can still be provided in the first embodiment on the condition that the system length has been shortened to about 4.454 mm. Therefore, according to the first embodiment, the length of the optical lens assembly can be shortened while good optical performance is ensured.

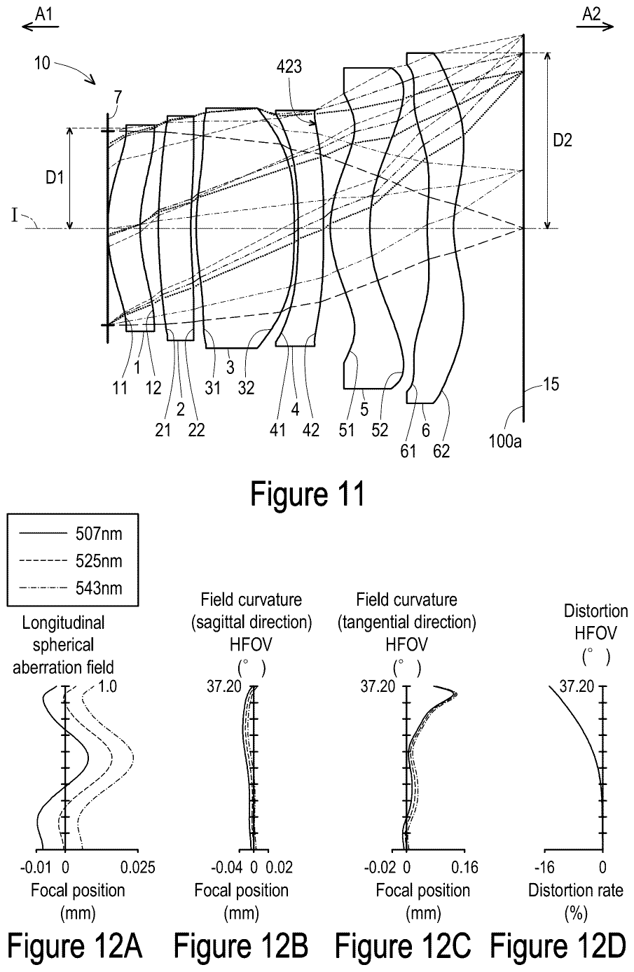

FIG. 11 is a schematic diagram of an optical lens assembly according to a second embodiment of the invention. FIG. 12A to FIG. 12D are diagrams of longitudinal spherical aberrations and various aberrations of the optical lens assembly according to the second embodiment. With reference to FIG. 11, the optical lens assembly 10 provided in the second embodiment of the invention is generally similar to that provided in the first embodiment, and the differences between the two lie in that: the optical data, the aspheric coefficients, and the parameters of these lens elements (for instance, the first lens element 1 to the sixth lens element 6) are more or less different. Moreover, in this embodiment, the periphery region 423 of the light input surface 42 of the fourth lens element 4 is concave. It should be noted that for the sake of clarity in the figure, some reference numbers for the optical axis region and the periphery region with the surface profiles similar to those provided in the first embodiment are omitted in FIG. 11.

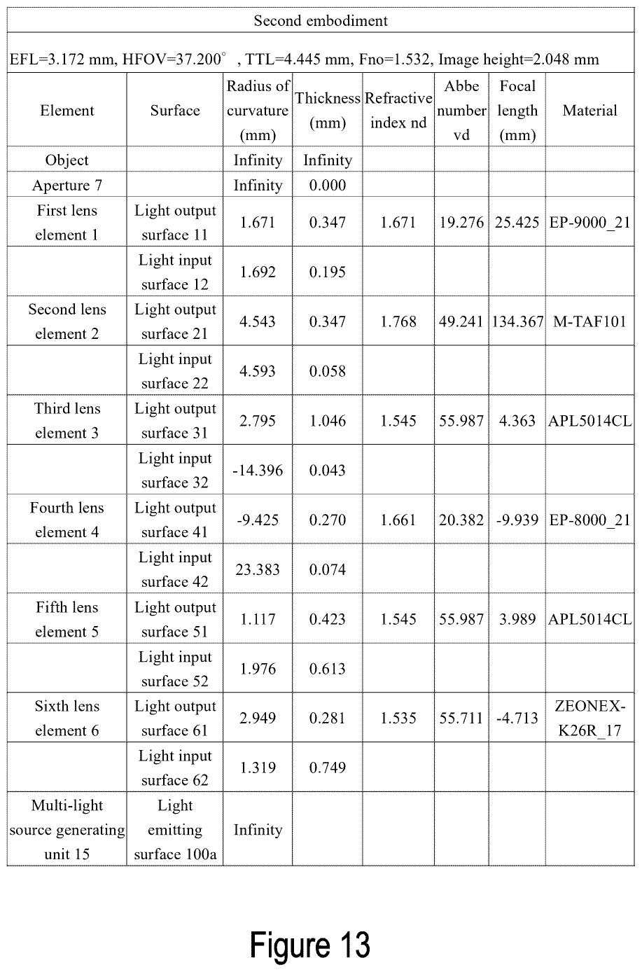

The detailed optical data of the optical lens assembly 10 provided in the second embodiment are shown in FIG. 13, and the optical lens assembly 10 provided in the second embodiment has a system focal length of 3.172 mm, a HFOV of 37.200°, a system length (TTL) of 4.445 mm, an Fno of 1.532, and an image height of 2.048 mm.

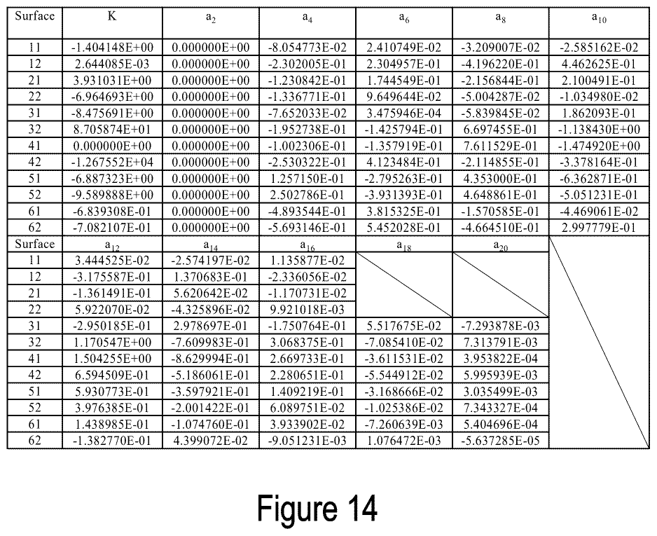

FIG. 14 illustrates aspheric coefficients for each item in the formula (1) from the light output surface 11 of the first lens element 1 to the light input surface 62 of the sixth lens element 6 according to the second embodiment.

In addition, relations among all important parameters in the optical lens assembly 10 provided in the second embodiment are shown in FIG. 43 and FIG. 45.

The longitudinal spherical aberrations provided in the second embodiment are shown in FIG. 12A, where the imaging point deviation of off-axis rays at different heights is controlled within the range of ±0.025 mm. In FIG. 12B and FIG. 12C, the two diagrams showing the field curvature aberrations, the focal length variation of the three representative wavelengths falls within +0.160 mm across the entire field of view. The distortion aberration diagram in FIG. 12D shows that the distortion aberrations provided in the second embodiment are maintained within the range of ±16%.

Through the above explanation, it can be understood that the system length provided in the second embodiment is shorter than that provided in the first embodiment. The longitudinal spherical aberrations and the field curvature aberrations provided in the second embodiment are superior to those provided in the first embodiment.

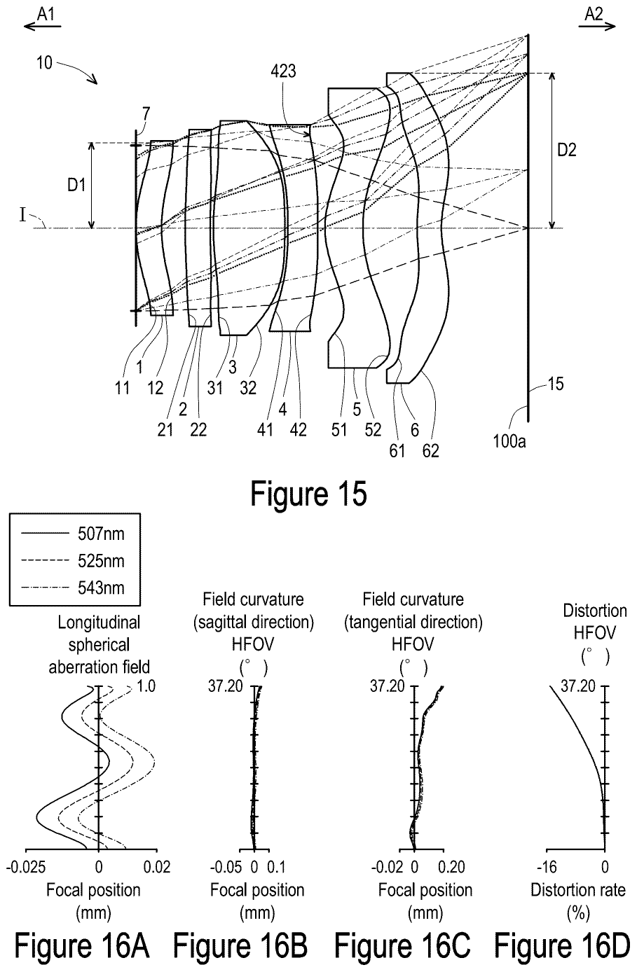

FIG. 15 is a schematic diagram of an optical lens assembly according to a third embodiment of the invention. FIG. 16A to FIG. 16D are diagrams of longitudinal spherical aberrations and various aberrations of the optical lens assembly according to the third embodiment. t. With reference to FIG. 15, the optical lens assembly 10 provided in the third embodiment of the invention is generally similar to that provided in the first embodiment, and the differences between the two lie in that: the optical data, the aspheric coefficients, and the parameters of these lens elements (for instance, the first lens element 1 to the sixth lens element 6) are more or less different. Moreover, in this embodiment, the periphery region 423 of the light input surface 42 of the fourth lens element 4 is concave. It should be noted that for the sake of clarity in the figure, some reference numbers for the optical axis region and the periphery region with the surface profiles similar to those provided in the first embodiment are omitted in FIG. 15.

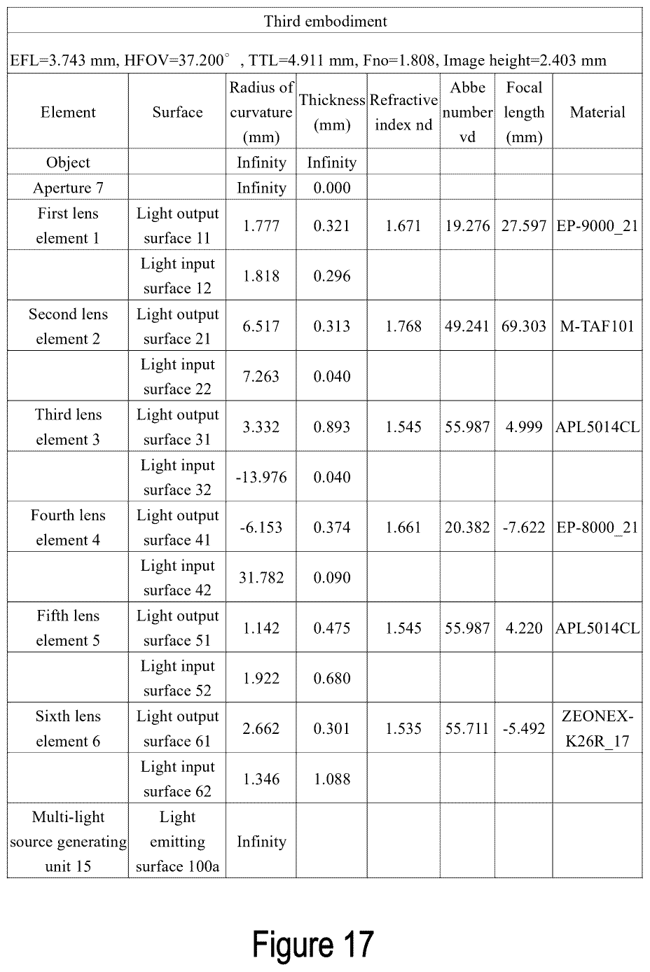

The detailed optical data of the optical lens assembly 10 provided in the third embodiment are shown in FIG. 17, and the optical lens assembly 10 provided in the third embodiment has a system focal length of 3.743 mm, a HFOV of 37.200°, a system length (TTL) of 4.911 mm, an Fno of 1.808, and an image height of 2.403 mm.

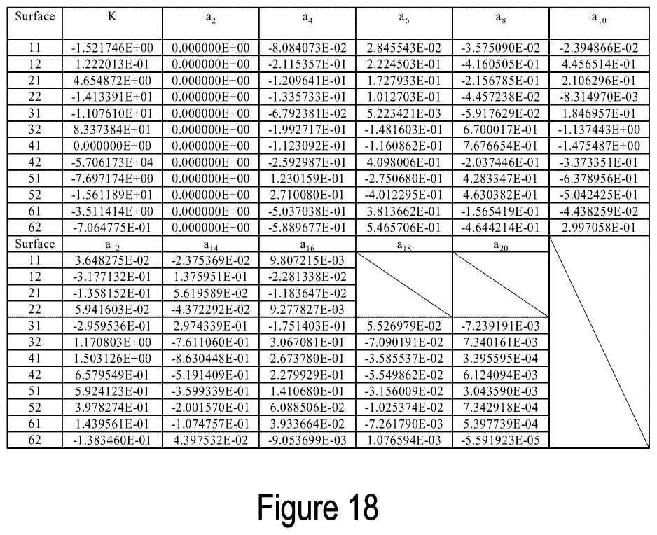

FIG. 18 illustrates aspheric coefficients for each item in the formula (1) from the light output surface 11 of the first lens element 1 to the light input surface 62 of the sixth lens element 6 according to the third embodiment.

In addition, relations among all important parameters in the optical lens assembly 10 provided in the third embodiment are shown in FIG. 43 and FIG. 45.

The longitudinal spherical aberrations provided in the third embodiment are shown in FIG. 16A, where the imaging point deviation of off-axis rays at different heights is controlled within the range of ±0.025 mm. In FIG. 16B and FIG. 16C, the two diagrams showing the field curvature aberrations, the focal length variation of the three representative wavelengths falls within +0.200 mm across the entire field of view. The distortion aberration diagram in FIG. 16D shows that the distortion aberrations provided in the third embodiment are maintained within the range of ±16%. Besides, the image height is relatively large according to the third embodiment.

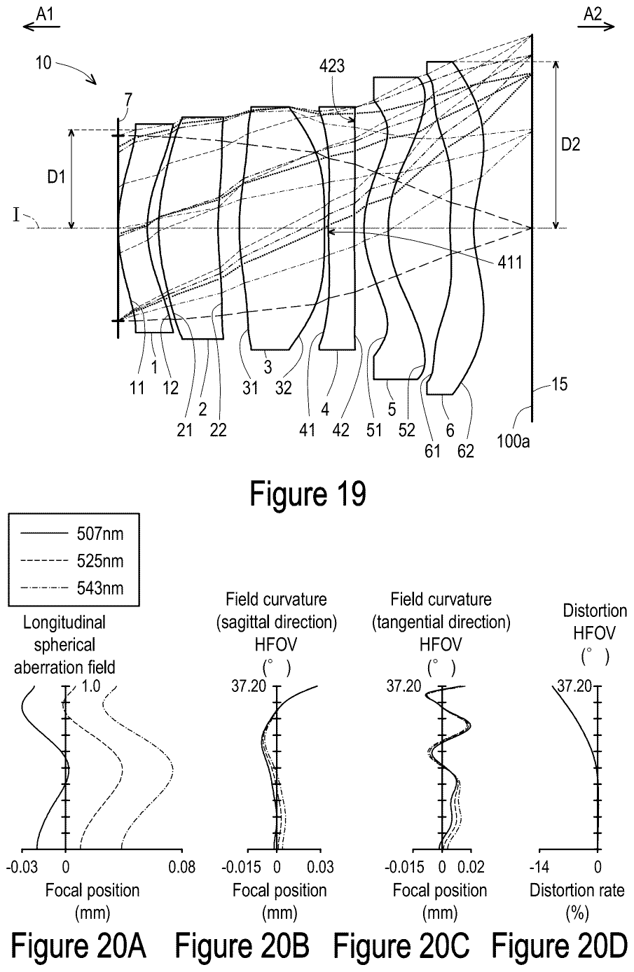

FIG. 19 is a schematic diagram of an optical lens assembly according to a fourth embodiment of the invention. FIG. 20A to FIG. 20D are diagrams of longitudinal spherical aberrations and various aberrations of the optical lens assembly according to the fourth embodiment. With reference to FIG. 19, the optical lens assembly 10 provided in the fourth embodiment of the invention is generally similar to that provided in the first embodiment, and the differences between the two lie in that: the optical data, the aspheric coefficients, and the parameters of these lens elements (for instance, the first lens element 1 to the sixth lens element 6) are more or less different. Moreover, in this embodiment, the first lens element 1 has negative refracting power. The fourth lens element 4 has positive refracting power. The optical axis region 411 of the light output surface 41 of the fourth lens element 4 is convex, and the periphery region 423 of the light input surface 42 of the fourth lens element 4 is concave. It should be noted that for the sake of clarity in the figure, some reference numbers for the optical axis region and the periphery region with the surface profiles similar to those provided in the first embodiment are omitted in FIG. 19.

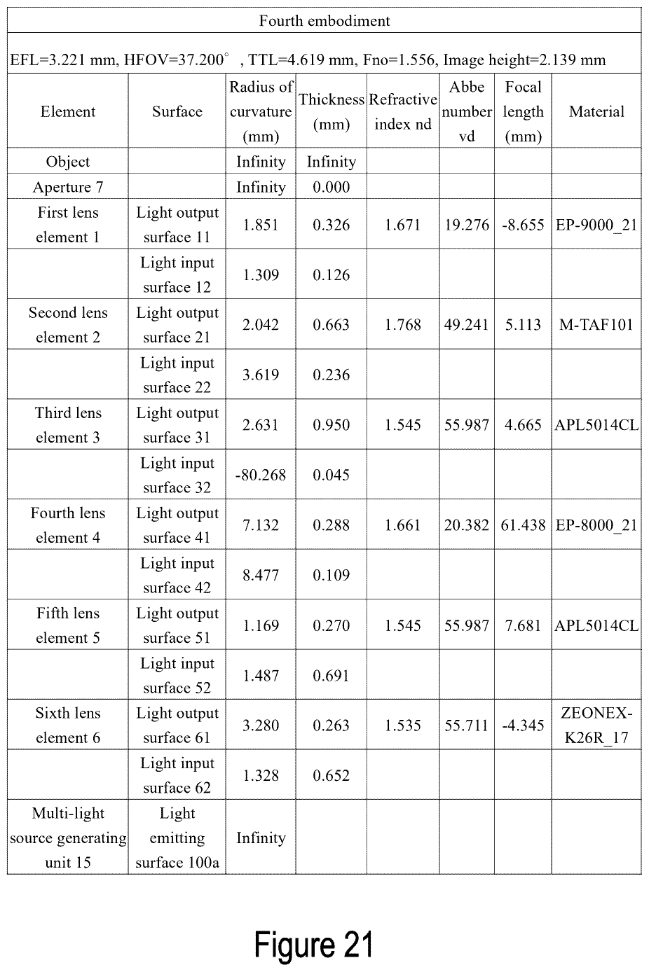

The detailed optical data of the optical lens assembly 10 provided in the fourth embodiment are shown in FIG. 21, and the optical lens assembly 10 provided in the fourth embodiment has a system focal length of 3.221 mm, a HFOV of 37.200°, a system length (TTL) of 4.619 mm, an Fno of 1.556, and an image height of 2.139 mm.

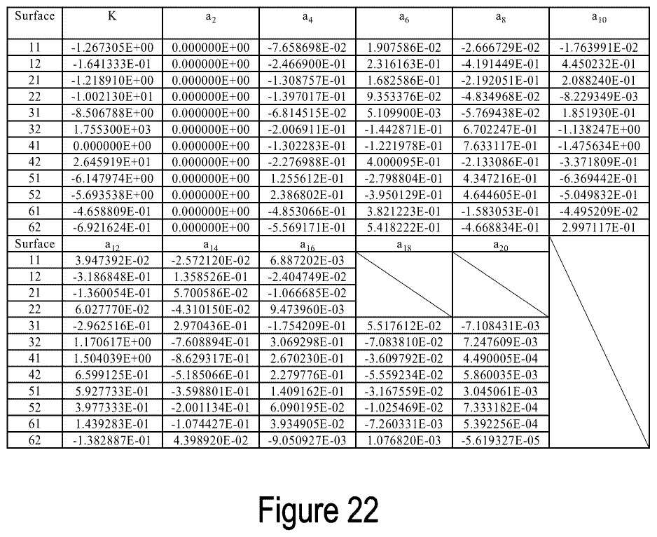

FIG. 22 illustrates aspheric coefficients for each item in the formula (1) from the light output surface 11 of the first lens element 1 to the light input surface 62 of the sixth lens element 6 according to the fourth embodiment.

In addition, relations among all important parameters in the optical lens assembly 10 provided in the fourth embodiment are shown in FIG. 43 and FIG. 45.

The longitudinal spherical aberrations provided in the fourth embodiment are shown in FIG. 20A, where the imaging point deviation of off-axis rays at different heights is controlled within the range of ±0.030 mm. In FIG. 20B and FIG. 20C, the two diagrams showing the field curvature aberrations, the focal length variation of the three representative wavelengths falls within +0.030 mm across the entire field of view. The distortion aberration diagram in FIG. 20D shows that the distortion aberrations provided in the fourth embodiment are maintained within the range of ±14%.

Through the above explanation, it can be understood that the field curvature aberrations and the distortion aberrations provided in the fourth embodiment are superior to those provided in the first embodiment. Moreover, the image height is relatively large according to the fourth embodiment.

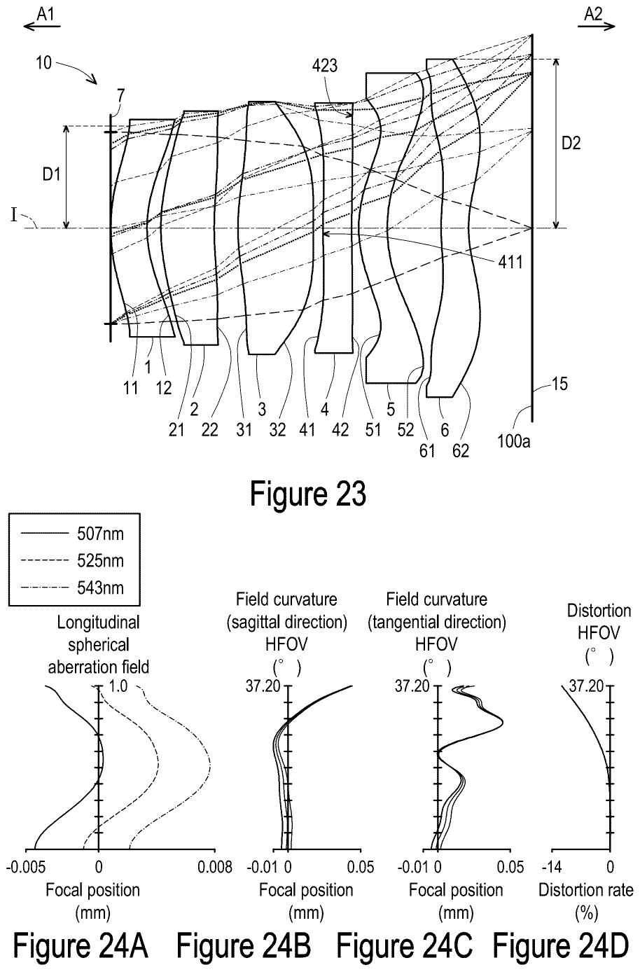

FIG. 23 is a schematic diagram of an optical lens assembly according to a fifth embodiment of the invention. FIG. 24A to FIG. 24D are diagrams of longitudinal spherical aberrations and various aberrations of the optical lens assembly according to the fifth embodiment. With reference to FIG. 23, the optical lens assembly 10 provided in the fifth embodiment of the invention is generally similar to that provided in the first embodiment, and the differences between the two lie in that: the optical data, the aspheric coefficients, and the parameters of these lens elements (for instance, the first lens element 1 to the sixth lens element 6) are more or less different. Moreover, in this embodiment, the first lens element 1 has negative refracting power. The fourth lens element 4 has positive refracting power. The optical axis region 411 of the light output surface 41 of the fourth lens element 4 is convex, and the periphery region 423 of the light input surface 42 of the fourth lens element 4 is concave. It should be noted that for the sake of clarity in the figure, some reference numbers for the optical axis region and the periphery region with the surface profiles similar to those provided in the first embodiment are omitted in FIG. 23.

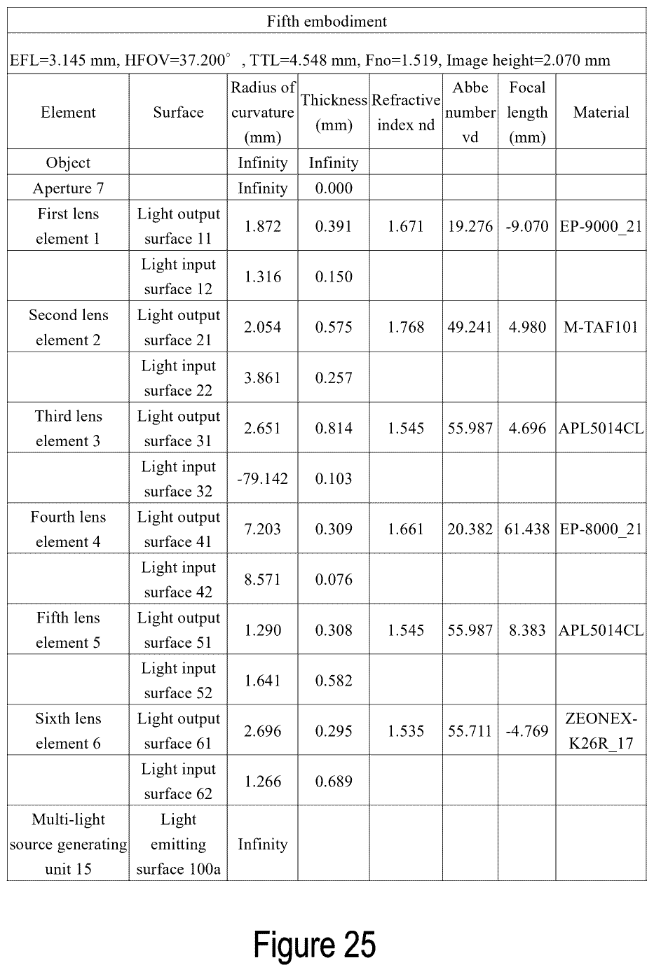

The detailed optical data of the optical lens assembly 10 provided in the fifth embodiment are shown in FIG. 25, and the optical lens assembly 10 provided in the fifth embodiment has a system focal length of 3.145 mm, a HFOV of 37.200°, a system length (TTL) of 4.548 mm, an Fno of 1.519, and an image height of 2.070 mm.

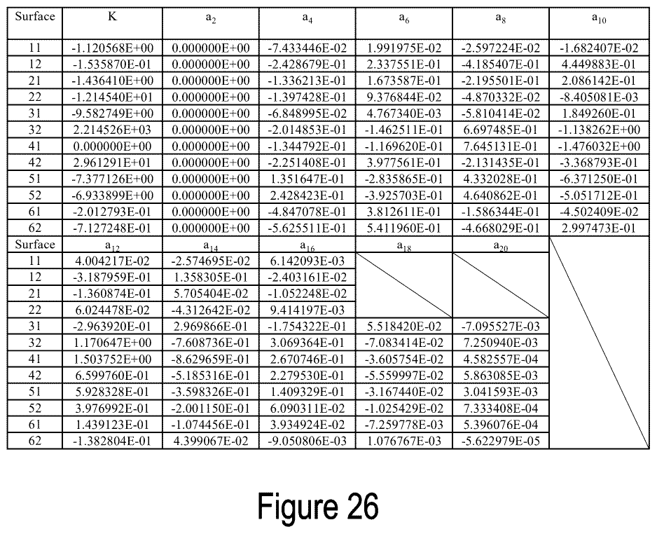

FIG. 26 illustrates aspheric coefficients for each item in the formula (1) from the light output surface 11 of the first lens element 1 to the light input surface 62 of the sixth lens element 6 according to the fifth embodiment.

In addition, relations among all important parameters in the optical lens assembly 10 provided in the fifth embodiment are shown in FIG. 43 and FIG. 45.

The longitudinal spherical aberrations provided in the fifth embodiment are shown in FIG. 24A, where the imaging point deviation of off-axis rays at different heights is controlled within the range of ±0.008 mm. In FIG. 24B and FIG. 24C, the two diagrams showing the field curvature aberrations, the focal length variation of the three representative wavelengths falls within ±0.050 mm across the entire field of view. The distortion aberration diagram in FIG. 24D shows that the distortion aberrations provided in the fifth embodiment are maintained within the range of ±14%.

Through the above explanation, it can be understood that the longitudinal spherical aberrations, the field curvature aberrations, and the distortion aberrations provided in the fifth embodiment are superior to those provided in the first embodiment. Moreover, the image height is relatively large according to the fifth embodiment.

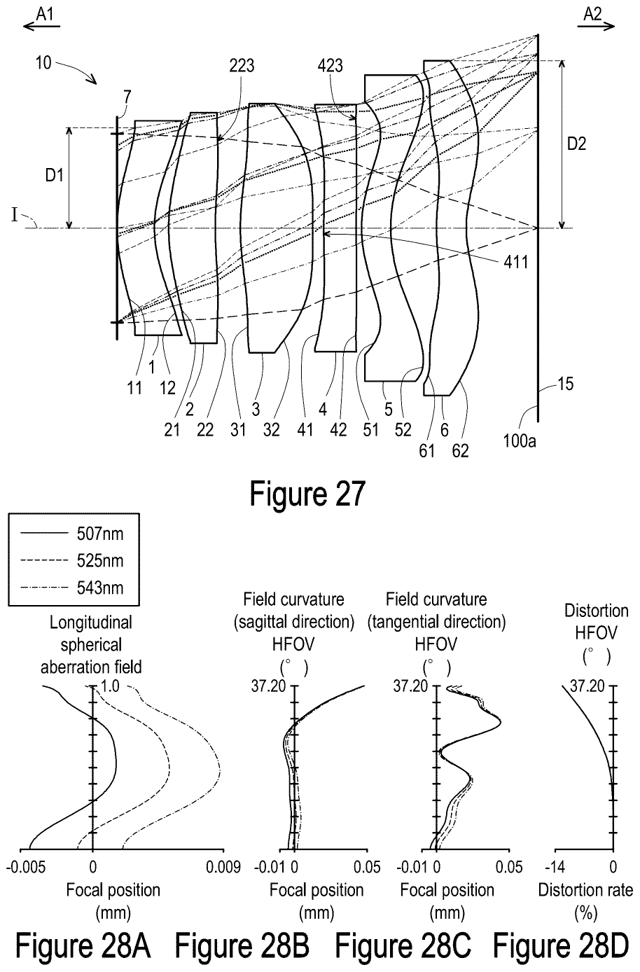

FIG. 27 is a schematic diagram of an optical lens assembly according to a sixth embodiment of the invention. FIG. 28A to FIG. 28D are diagrams of longitudinal spherical aberrations and various aberrations of the optical lens assembly according to the sixth embodiment. With reference to FIG. 27, the optical lens assembly 10 provided in the sixth embodiment of the invention is generally similar to that provided in the first embodiment, and the differences between the two lie in that: the optical data, the aspheric coefficients, and the parameters of these lens elements (for instance, the first lens element 1 to the sixth lens element 6) are more or less different. Moreover, in this embodiment, the first lens element 1 has negative refracting power. The periphery region 223 of the light input surface 22 of the second lens element 2 is convex. The fourth lens element 4 has positive refracting power. The optical axis region 411 of the light output surface 41 of the fourth lens element 4 is convex, and the periphery region 423 of the light input surface 42 of the fourth lens element 4 is concave. It should be noted that for the sake of clarity in the figure, some reference numbers for the optical axis region and the periphery region with the surface profiles similar to those provided in the first embodiment are omitted in FIG. 27.

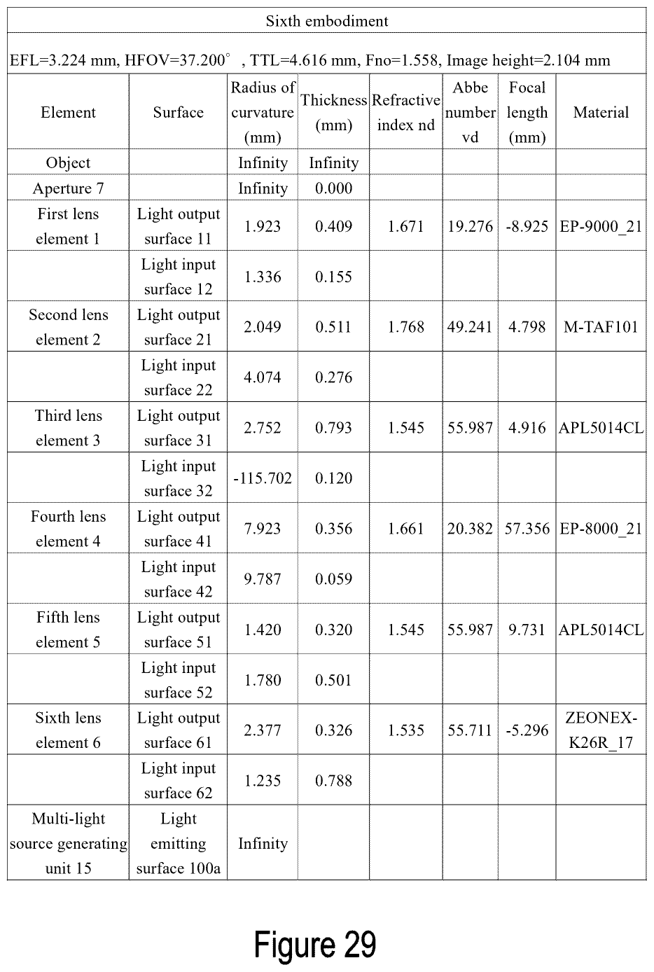

The detailed optical data of the optical lens assembly 10 provided in the sixth embodiment are shown in FIG. 29, and the optical lens assembly 10 provided in the sixth embodiment has a system focal length of 3.224 mm, a HFOV of 37.200°, a system length (TTL) of 4.616 mm, an Fno of 1.558, and an image height of 2.104 mm.

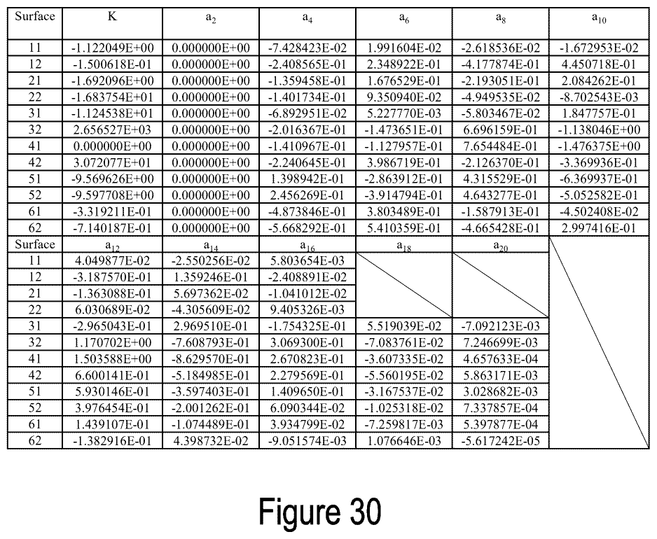

FIG. 30 illustrates aspheric coefficients for each item in the formula (1) from the light output surface 11 of the first lens element 1 to the light input surface 62 of the sixth lens element 6 according to the sixth embodiment.

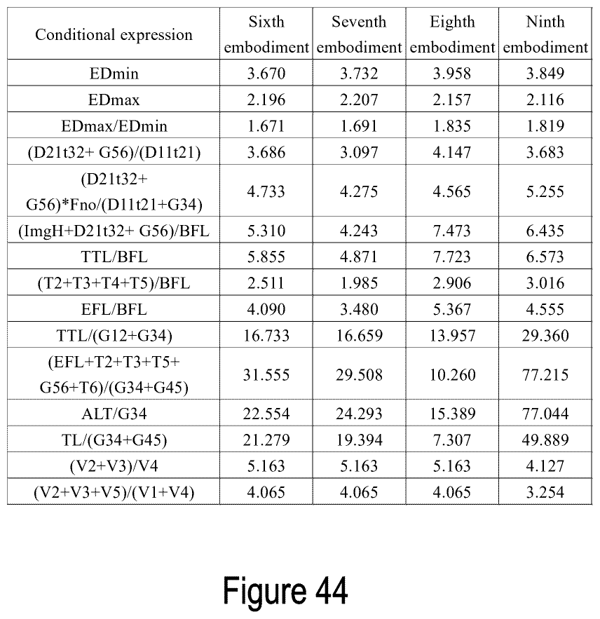

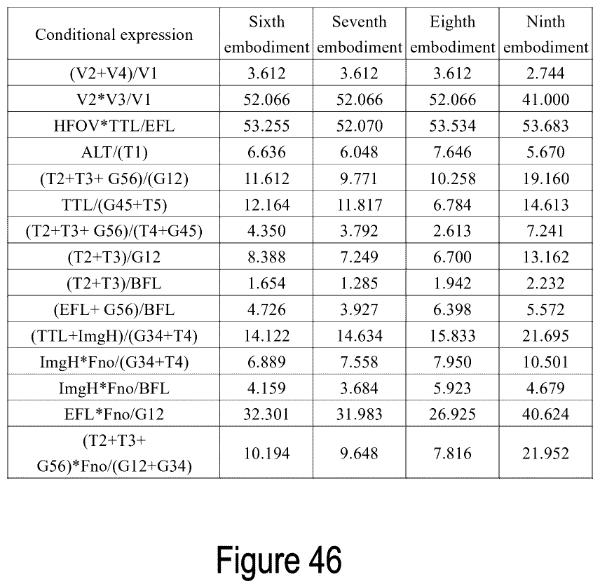

In addition, relations among all important parameters in the optical lens assembly 10 provided in the sixth embodiment are shown in FIG. 44 and FIG. 46.

The longitudinal spherical aberrations provided in the sixth embodiment are shown in FIG. 28A, where the imaging point deviation of off-axis rays at different heights is controlled within the range of ±0.009 mm. In FIG. 28B and FIG. 28C, the two diagrams showing the field curvature aberrations, the focal length variation of the three representative wavelengths falls within ±0.050 mm across the entire field of view. The distortion aberration diagram in FIG. 28D shows that the distortion aberrations provided in the sixth embodiment are maintained within the range of ±14%.

Through the above explanation, it can be understood that the longitudinal spherical aberrations, the field curvature aberrations, and the distortion aberrations provided in the sixth embodiment are superior to those provided in the first embodiment. Moreover, the image height is relatively large according to the sixth embodiment.

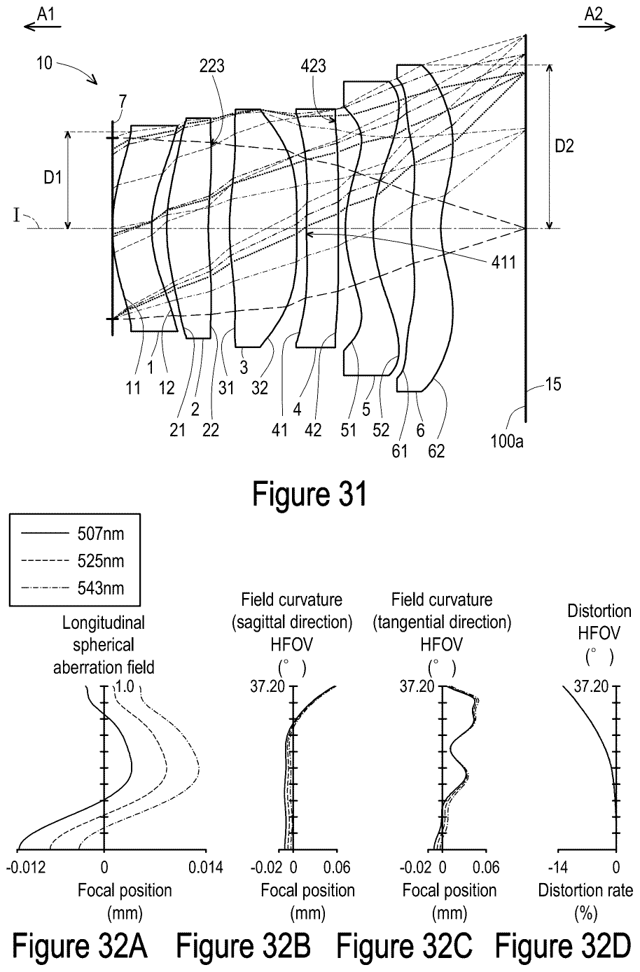

FIG. 31 is a schematic diagram of an optical lens assembly according to a seventh embodiment of the invention. FIG. 32A to FIG. 32D are diagrams of longitudinal spherical aberrations and various aberrations of the optical lens assembly according to the seventh embodiment. With reference to FIG. 31, the optical lens assembly 10 provided in the seventh embodiment of the invention is generally similar to that provided in the first embodiment, and the differences between the two lie in that: the optical data, the aspheric coefficients, and the parameters of these lens elements (for instance, the first lens element 1 to the sixth lens element 6) are more or less different. Moreover, in this embodiment, the first lens element 1 has negative refracting power. The periphery region 223 of the light input surface 22 of the second lens element 2 is convex. The fourth lens element 4 has positive refracting power. The optical axis region 411 of the light output surface 41 of the fourth lens element 4 is convex, and the periphery region 423 of the light input surface 42 of the fourth lens element 4 is concave. It should be noted that for the sake of clarity in the figure, some reference numbers for the optical axis region and the periphery region with the surface profiles similar to those provided in the first embodiment are omitted in FIG. 31.

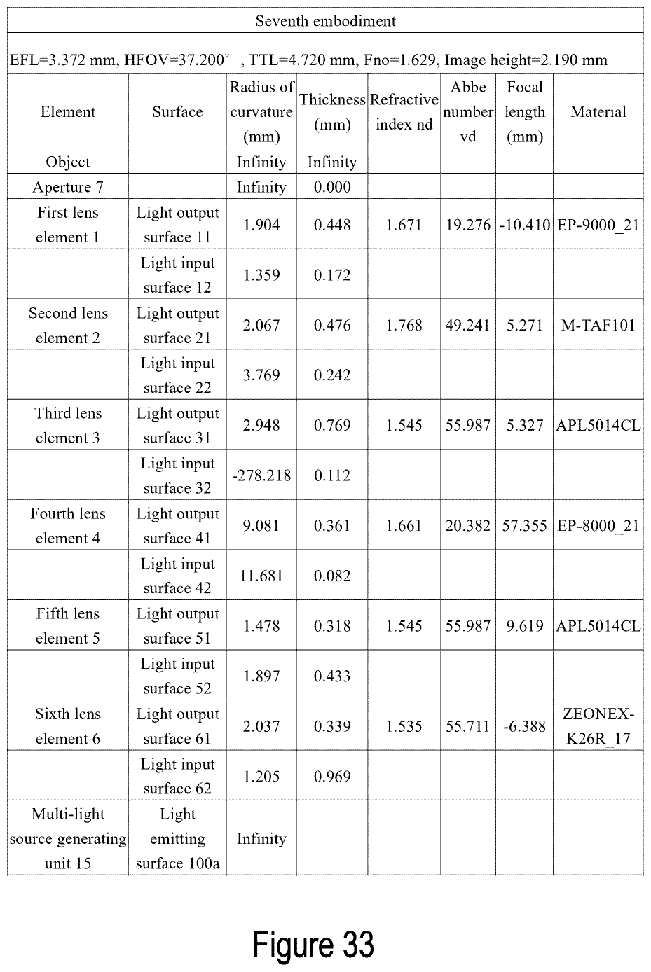

The detailed optical data of the optical lens assembly 10 provided in the seventh embodiment are shown in FIG. 33, and the optical lens assembly 10 provided in the seventh embodiment has a system focal length of 3.372 mm, a HFOV of 37.200°, a system length (TTL) of 4.720 mm, an Fno of 1.629, and an image height of 2.190 mm.

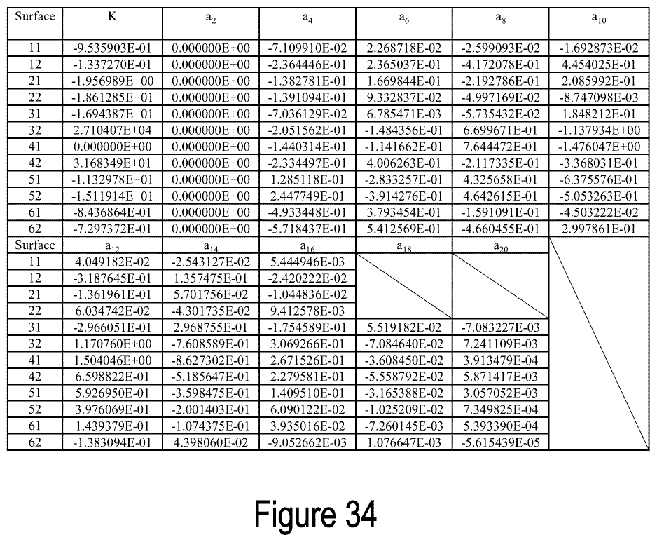

FIG. 34 illustrates aspheric coefficients for each item in the formula (1) from the light output surface 11 of the first lens element 1 to the light input surface 62 of the sixth lens element 6 according to the seventh embodiment.

In addition, relations among all important parameters in the optical lens assembly 10 provided in the seventh embodiment are shown in FIG. 44 and FIG. 46.

The longitudinal spherical aberrations provided in the seventh embodiment are shown in FIG. 32A, where the imaging point deviation of off-axis rays at different heights is controlled within the range of ±0.014 mm. In FIG. 32B and FIG. 32C, the two diagrams showing the field curvature aberrations, the focal length variation of the three representative wavelengths falls within ±0.06 mm across the entire field of view. The distortion aberration diagram in FIG. 32D shows that the distortion aberrations provided in the seventh embodiment are maintained within the range of ±14%.

Through the above explanation, it can be understood that the longitudinal spherical aberrations, the field curvature aberrations, and the distortion aberrations provided in the seventh embodiment are superior to those provided in the first embodiment. Moreover, the image height is relatively large according to the seventh embodiment.

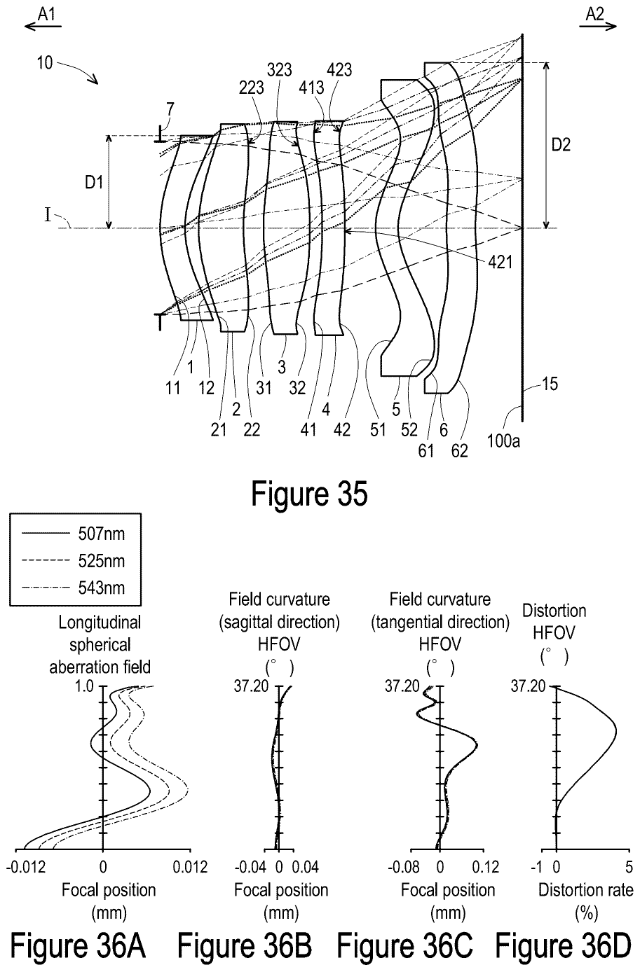

FIG. 35 is a schematic diagram of an optical lens assembly according to an eighth embodiment of the invention. FIG. 36A to FIG. 36D are diagrams of longitudinal spherical aberrations and various aberrations of the optical lens assembly according to the eighth embodiment. With reference to FIG. 35, the optical lens assembly 10 provided in the eighth embodiment of the invention is generally similar to that provided in the first embodiment, and the differences between the two lie in that: the optical data, the aspheric coefficients, and the parameters of these lens elements (for instance, the first lens element 1 to the sixth lens element 6) are more or less different. Moreover, in this embodiment, the first lens element 1 has negative refracting power. The periphery region 223 of the light input surface 22 of the second lens element 2 is convex. The periphery region 323 of the light input surface 32 of the third lens element 3 is concave. The periphery region 413 of the light output surface 41 of the fourth lens element 4 is convex, the optical axis region 421 of the light input surface 42 of the fourth lens element 4 is convex, and the periphery region 423 of the light input surface 42 of the fourth lens element 4 is concave. The sixth lens element 6 has positive refracting power. It should be noted that for the sake of clarity in the figure, some reference numbers for the optical axis region and the periphery region with the surface profiles similar to those provided in the first embodiment are omitted in FIG. 35.

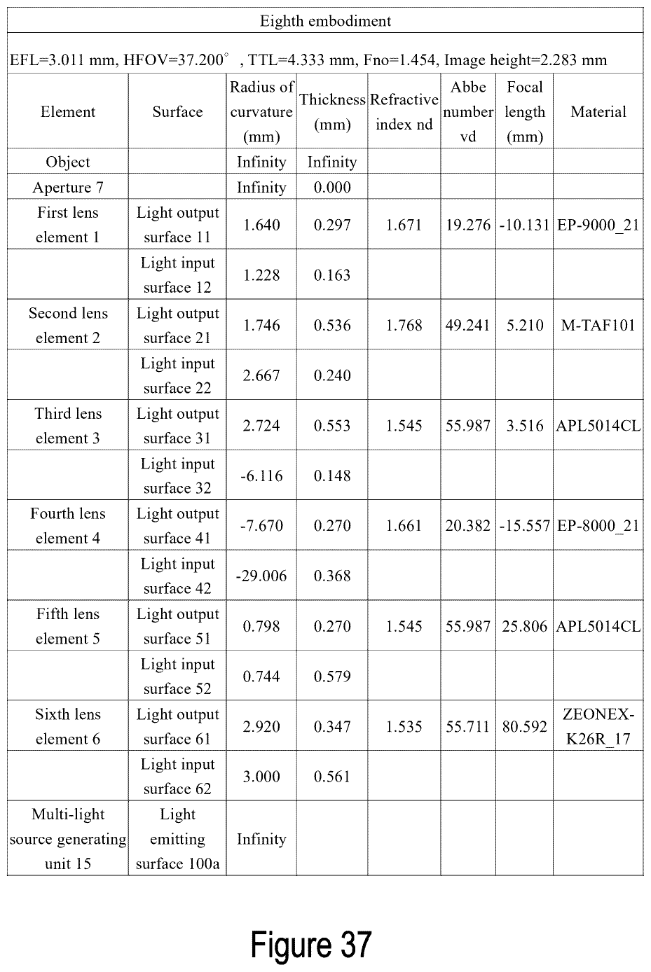

The detailed optical data of the optical lens assembly 10 provided in the eighth embodiment are shown in FIG. 37, and the optical lens assembly 10 provided in the eighth embodiment has a system focal length of 3.011 mm, a HFOV of 37.200°, a system length (TTL) of 4.333 mm, an Fno of 1.454, and an image height of 2.283 mm.

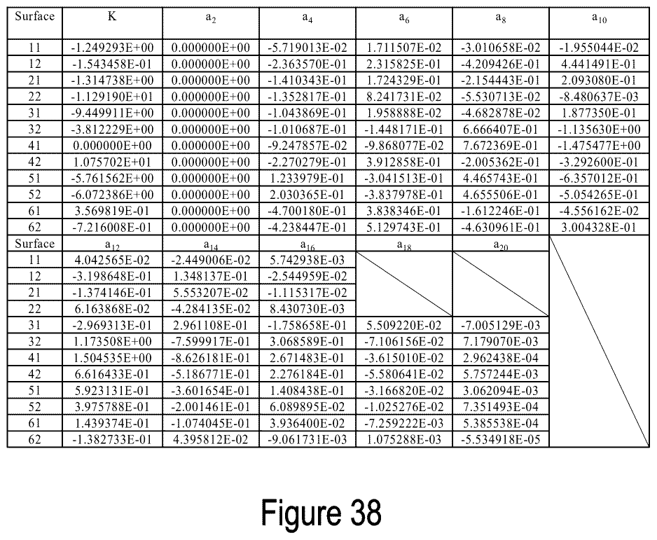

FIG. 38 illustrates aspheric coefficients for each item in the formula (1) from the light output surface 11 of the first lens element 1 to the light input surface 62 of the sixth lens element 6 according to the eighth embodiment.

In addition, relations among all important parameters in the optical lens assembly 10 provided in the eighth embodiment are shown in FIG. 44 and FIG. 46.

The longitudinal spherical aberrations provided in the eighth embodiment are shown in FIG. 36A, where the imaging point deviation of off-axis rays at different heights is controlled within the range of ±0.012 mm. In FIG. 36B and FIG. 36C, the two diagrams showing the field curvature aberrations, the focal length variation of the three representative wavelengths falls within ±0.120 mm across the entire field of view. The distortion aberration diagram in FIG. 36D shows that the distortion aberrations provided in the eighth embodiment are maintained within the range of ±5%.

Through the above explanation, it can be understood that the system length provided in the eighth embodiment is shorter than that provided in the first embodiment. The longitudinal spherical aberrations, the field curvature aberrations, and the distortion aberrations provided in the eighth embodiment are superior to those provided in the first embodiment. Moreover, the image height is relatively large according to the eighth embodiment.

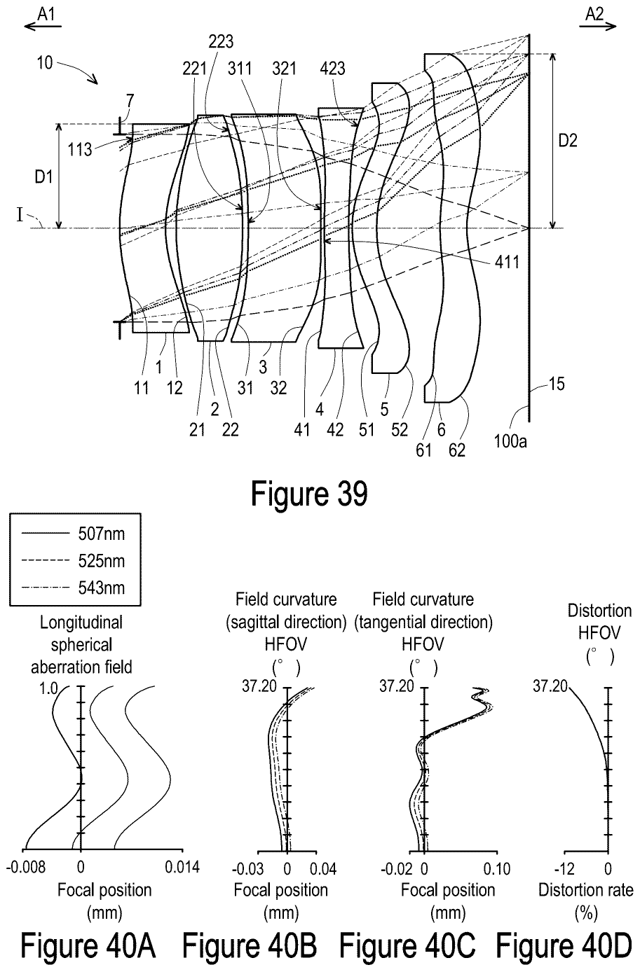

FIG. 39 is a schematic diagram of an optical lens assembly according to a ninth embodiment of the invention. FIG. 40A to FIG. 40D are diagrams of longitudinal spherical aberrations and various aberrations of the optical lens assembly according to the ninth embodiment. With reference to FIG. 39, the optical lens assembly 10 provided in the ninth embodiment of the invention is generally similar to that provided in the first embodiment, and the differences between the two lie in that: the optical data, the aspheric coefficients, and the parameters of these lens elements (for instance, the first lens element 1 to the sixth lens element 6) are more or less different. Moreover, in this embodiment, the first lens element 1 has negative refracting power. The periphery region 113 of the light output surface 11 of the first lens element 1 is concave. The optical axis region 221 of the light input surface 22 of the second lens element 2 is convex, and the periphery region 223 of the light input surface 22 of the second lens element 2 is convex. The third lens element 3 has negative refracting power. The optical axis region 311 of the light output surface 31 of the third lens element 3 is concave, and the optical axis region 321 of the light input surface 32 of the third lens element 3 is concave. The optical axis region 411 of the light output surface 41 of the fourth lens element 4 is convex, and the periphery region 423 of the light input surface 42 of the fourth lens element 4 is concave. It should be noted that for the sake of clarity in the figure, some reference numbers for the optical axis region and the periphery region with the surface profiles similar to those provided in the first embodiment are omitted in FIG. 39.

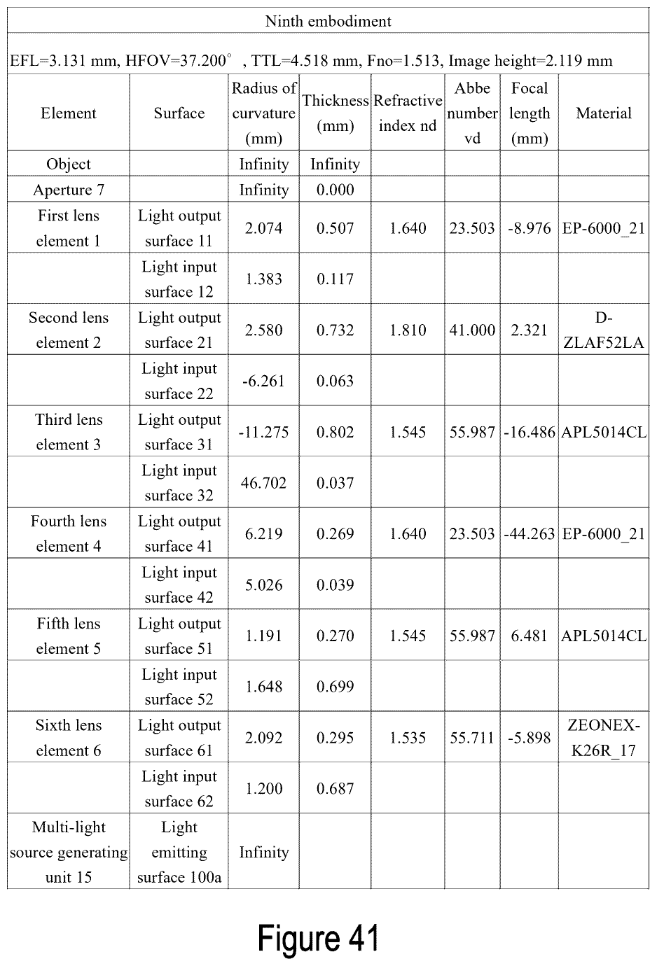

The detailed optical data of the optical lens assembly 10 provided in the ninth embodiment are shown in FIG. 41, and the optical lens assembly 10 provided in the ninth embodiment has a system focal length of 3.131 mm, a half field of view (HFOV) of 37.200°, a system length (TTL) of 4.518 mm, an Fno of 1.513, and an image height of 2.119 mm.

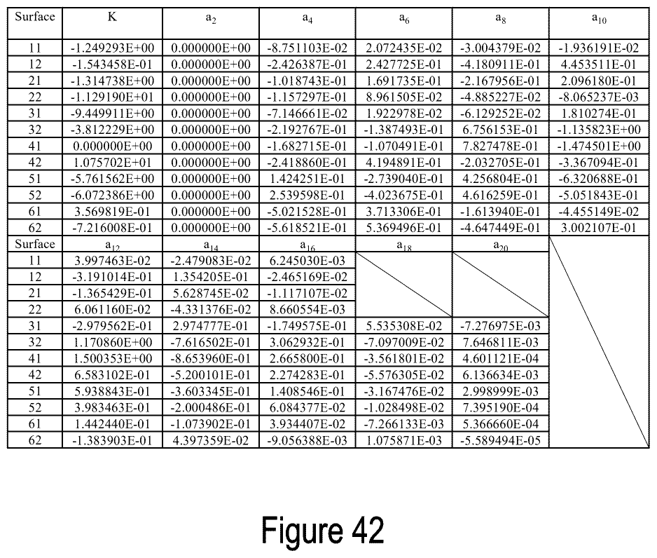

FIG. 42 illustrates aspheric coefficients for each item in the formula (1) from the light output surface 11 of the first lens element 1 to the light input surface 62 of the sixth lens element 6 according to the ninth embodiment.

In addition, relations among all important parameters in the optical lens assembly 10 provided in the ninth embodiment are shown in FIG. 44 and FIG. 46.

The longitudinal spherical aberrations provided in the ninth embodiment are shown in FIG. 40A, where the imaging point deviation of off-axis rays at different heights is controlled within the range of ±0.014 mm. In FIG. 40B and FIG. 40C, the two diagrams showing the field curvature aberrations, the focal length variation of the three representative wavelengths falls within ±0.100 mm across the entire field of view. The distortion aberration diagram in FIG. 40D shows that the distortion aberrations provided in the ninth embodiment are maintained within the range of ±12%.

Through the above explanation, it can be understood that the longitudinal spherical aberrations, the field curvature aberrations, and the distortion aberrations provided in the ninth embodiment are superior to those provided in the first embodiment. Moreover, the image height is relatively large according to the ninth embodiment.

In summary, the optical lens assembly 10 provided in one or more embodiments of the invention may achieve at least the following effects and advantages:
1. The optical lens assembly 10 satisfies the conditional expression EDmax/EDmin≤2.100, which is conducive to effectively converging the chief rays and marginal rays from the light input side A2, allowing a high proportion of the chief rays and the marginal rays to be projected to the light output side A1, thereby enhancing the projection effect. EDmax is the maximum value of the effective diameters of the first lens element 1 to the sixth lens element 6, and EDmin is the minimum value of the effective diameters of the first lens element 1 to the sixth lens element 6. The effective diameter of one lens element generally refers to a radial distance between two optical boundaries OB (e.g., with reference to FIG. 3 to FIG. 6) on the two opposite sides of the lens element on the optical axis I. In the first embodiment to the ninth embodiment, EDmin is, for instance, twice the distance D1, and EDmax is, for instance, twice the distance D2. When the fifth lens element 5 has positive refracting power, the optical axis region 621 of the light input surface 62 of the sixth lens element 6 is concave, the periphery region 623 of the light input surface 62 of the sixth lens element 6 is convex, and the periphery region 611 of the light output surface 61 of the sixth lens element 6 is concave, rays from different angles can be converged (or gathered), correcting aberrations in the center field of view of the imaging surface along with the surface profile of the periphery region of a specific lens element. Moreover, the conditional expression 3.000≤(D21t32+G56)/D11t21 can be satisfied, which contributes to providing the optical lens assembly 10 with the projection lens element that has a smaller system length and better quality. In an embodiment of the invention, preferably, 3.000≤(D21t32+G56)/D11t21≤5.700.
2. Following from 1, when the condition that the second lens element 2 has positive refracting power is further satisfied, both assembly yield and imaging quality can be improved.
3. The optical lens assembly 10 satisfies the conditional expression EDmax/EDmin≤2.100, which is conducive to effectively converging the chief rays and the marginal rays from the light input side A2, allowing a high proportion of the chief rays and the marginal rays to be projected to the light output side A1, thereby enhancing the projection effect. When the fifth lens element 5 has positive refracting power, the optical axis region 211 of the light output surface 21 of the second lens element 2 is convex, the optical axis region 621 of the light input surface 62 of the sixth lens element 6 is concave, and the periphery region 611 of the light output surface 61 of the sixth lens element 6 is concave, rays from different angles can be converged (or gathered), correcting aberrations in the center field of view of the imaging surface along with the surface profile of the periphery region of a specific lens element. Moreover, the conditional expression 4.100≤(D21t32+G56)*Fno/(D11t21+G34) can be satisfied, which contributes to providing the optical lens assembly 10 with the projection lens element that has a smaller system length and better quality. In an embodiment of the invention, preferably, 4.100≤(D21t32+G56)*Fno/(D11t21+G34)≤8.000.
4. Following from 3, when the condition that the second lens element 2 has positive refracting power is further satisfied, both assembly yield and imaging quality can be improved.
5. The optical lens assembly 10 satisfies the conditional expression EDmax/EDmin≤2.100, which is conducive to effectively converging the chief rays and the marginal rays from the light input side A2, allowing a high proportion of the chief rays and the marginal rays to be projected to the light output side A1, thereby enhancing the projection effect. When the fifth lens element 5 has positive refracting power, the periphery region 511 of the light output surface 51 of the fifth lens element 5 is concave, the optical axis region 621 of the light input surface 62 of the sixth lens element 6 is concave, and the periphery region 613 of the light output surface 61 of the sixth lens element 6 is concave, rays from different angles can be converged (or gathered), correcting aberrations in the center field of view of the imaging surface along with the surface profile of the periphery region of a specific lens element. Moreover, the conditional expression 4.100≤(D21t32+G56)*Fno/(D11t21+G34) can be satisfied, which contributes to providing an optical lens assembly 10 with the projection lens element that has a smaller system length for and better quality. In an embodiment of the invention, preferably, 4.100≤(D21t32+G56)*Fno/(D11t21+G34)≤8.000.
6. Following from 5, when the condition that the second lens element 2 has positive refracting power is further satisfied, both assembly yield and imaging quality can be improved.
7. When the lens element materials conform to the following configuration relations, it is conducive to the transmission and refraction of rays and effectively improving chromatic aberrations, enabling the optical lens assembly 10 to have excellent optical quality.

| | | |
|---|---|---|
| | Conditional | |
| Conditional | expression range | Preferable range |

| expression | min | max | min | max |
|---|---|---|---|---|
| (V2 + V3)/V4 | 3.700 | | 4.100 | 5.200 |
| (V2 + V3 + V5)/ | 2.900 | | 3.200 | 4.100 |
| (V1 + V4) | | | | |
| (V2 + V4)/V1 | 2.400 | | 2.700 | 3.700 |
| V2*V3/V1 | 36.900 | | 41.000 | 52.100 |

8. The optical lens assembly 10 provided in one or more embodiments of the invention further satisfies the following conditional expressions, which is conducive to maintaining adequate values of the effective focal length and various optical parameters, avoiding any parameter from being too large to be detrimental to the overall aberration correction of the optical lens assembly 10, or avoiding any parameter from being too small to affect assembly or increase manufacturing difficulties.

| | Conditional | | | |
|---|---|---|---|---|
| Conditional | expression range | | Preferable range | |
| expression | min | max | min | max |
| TTL/BFL | 4.000 | | 4.500 | 7.800 |
| (T2 + T3 + | 1.600 | | 1.800 | 3.500 |
| T4 + T5)/BFL | | | | |
| EFL/BFL | 3.000 | | 3.400 | 5.400 |
| (EFL + T2 + T3 + T5 + | 9.200 | | 10.200 | 77.300 |
| G56 + T6)/(G34 + G45) | | | | |
| HFOV*TTL/EFL | 43.900 | | 48.800 | 53.900 |
| (unit: degree) | | | | |
| (T2 + T3)/BFL | 0.900 | | 1.100 | 2.500 |
| (EFL + G56)/BFL | 3.500 | | 3.900 | 6.400 |
| ImgH*Fno/BFL | 3.300 | | 3.600 | 6.000 |
| EFL*Fno/G12 | 20.500 | | 22.800 | 40.700 |

9. The optical lens assembly 10 of the invention further satisfies the following conditional expressions, which is conducive to maintaining adequate values of the thickness and the spacing of each lens element, avoiding any parameter from being too large to be detrimental to the overall thinning of the optical lens assembly 10, or avoiding any parameter from being too small to affect assembly or increase manufacturing difficulties.

| | Conditional | | | |
|---|---|---|---|---|
| Conditional | expression range | | Preferable range | |
| expression | min | max | min | max |
| TTL/(G12 + G34) | 12.500 | | 13.000 | 29.400 |
| ALT/G34 | 13.800 | | 15.300 | 77.100 |
| TL/(G34 + G45) | 6.500 | | 7.300 | 50.000 |
| ALT/T1 | 5.100 | | 5.600 | 8.500 |
| (T2 + T3 + G56)/G12 | 5.700 | | 6.300 | 19.200 |
| TTL/(G45 + T5) | 6.100 | | 6.700 | 14.700 |
| (T2 + T3 + G56)/(T4 + G45) | 2.300 | | 2.600 | 7.300 |
| (T2 + T3)/G12 | 3.600 | | 4.000 | 13.200 |
| (TTL + ImgH)/(G34 + T4) | 12.700 | | 14.100 | 21.700 |
| ImgH*Fno/(G34 + T4) | 6.200 | | 6.800 | 10.600 |
| (T2 + T3 + G56)*Fno/ | 7.000 | | 7.800 | 22.000 |
| (G12 + G34) | | | | |
| (ImgH + D21t32 + G56)/BFL | 3.900 | | 3.9000 | 7.500 |

In addition, any combination relationships of the parameters of the embodiments may be additionally selected to add limits to the optical imaging lens element, so as to facilitate the optical imaging lens element design of the same architecture of the invention.

In view of the unpredictability of an optical system design, under the architecture of the invention, the optical imaging lens element, satisfying the foregoing conditional expressions, of the invention may have a reduced system length, an increased available aperture, improved imaging quality or increased assembling yield to improve the defect in the prior art.

The above-listed exemplary limitation relational expressions can also be arbitrarily selectively incorporated in unequal numbers to be applied to the embodiments of the invention, and they are not limited thereto. During the implementation of the invention, in addition to the aforementioned relational expressions, detailed structures, such as the arrangement of concave and convex surfaces, of other more lens elements can also be designed for a single lens element or broadly for a plurality of lens elements to enhance the system performance and/or control of the resolution. It should be noted that these details need to be selectively incorporated in other embodiments of the invention without conflicts.

The numerical ranges including the maximum and minimum values obtained from the combination ratio relations of the optical parameters disclosed in each embodiment of the invention can all be implemented accordingly.

The contents in the embodiments of the invention include but are not limited to a focal length, a thickness of a lens element, an Abbe number Vd, or other optical parameters. For example, in the embodiments of the invention, an optical parameter A and an optical parameter B are disclosed, wherein the ranges of the optical parameters, comparative relation between the optical parameters, and the range of a conditional expression covered by a plurality of embodiments are specifically explained as follows:
(1) The ranges of the optical parameters are, for example, α₂≤A≤α₁ or β₂≤B≤β₁, where α₁ is a maximum value of the optical parameter A among the plurality of embodiments, α₂ is a minimum value of the optical parameter A among the plurality of embodiments, β₁ is a maximum value of the optical parameter B among the plurality of embodiments, and β₂ is a minimum value of the optical parameter B among the plurality of embodiments.
(2) The comparative relation between the optical parameters is that A is greater than B or A is less than B, for example.
(3) The range of a conditional expression covered by a plurality of embodiments is in detail a combination relation or proportional relation obtained by a possible operation of a plurality of optical parameters in each same embodiment. The relation is defined as E, and E is, for example, A+B or A−B or A/B or A*B or (A*B)^{1/2}, and E satisfies a conditional expression E≤γ₁ or E≥γ₂ or γ≤E≤γ₁, where each of γ₁ and γ₂ is a value obtained by an operation of the optical parameter A and the optical parameter B in a same embodiment, γ₁ is a maximum value among the plurality of the embodiments, and γ₂ is a minimum value among the plurality of the embodiments.

The ranges of the aforementioned optical parameters, the aforementioned comparative relations between the optical parameters, and a maximum value, a minimum value, and the numerical range between the maximum value and the minimum value of the aforementioned conditional expressions are all implementable and all belong to the scope disclosed by the invention. The aforementioned description is for exemplary explanation, which should however not be construed as a limitation herein.

The embodiments of the invention are all implementable. In addition, a combination of partial features in a same embodiment can be selected, and the combination of partial features can achieve the unexpected result of the invention with respect to the prior art. The combination of partial features includes but is not limited to the surface shape of a lens element, refracting power, a conditional expression or the like, or a combination thereof. The description of the embodiments is for explaining the specific embodiments of the principles of the invention, which should however not be construed as a limitation herein. Specifically, the embodiments and the drawings are for exemplifying, which should however not be construed as a limitation herein.

The invention has been disclosed above with embodiments; however, the embodiments are not intended to limit the invention. Any person of ordinary skill in the art can make some changes and modifications without departing from the spirit and scope of the invention. Thus, the protection scope of the invention should be subject to that defined by the appended claims.

What is claimed is:

1. An optical lens assembly, adapted to a projection lens element, wherein a plurality of light emitted by a multi-light source generating unit pass through the optical lens assembly to generate a plurality of light beams, a direction towards the multi-light source generating unit is a light input side, an opposite side of the light input side is a light output side, the optical lens assembly comprises a first lens element, a second lens element, a third lens element, a fourth lens element, a fifth lens element, and a sixth lens element from the light output side to the light input side along an optical axis, and each of the first lens element, the second lens element, the third lens element, the fourth lens element, the fifth lens element, and the sixth lens element comprises a light output surface facing the light output side and a light input surface facing the light input side,
wherein
the fifth lens element has positive refracting power,
an optical axis region of the light input surface of the sixth lens element is concave and a periphery region of the light input surface of the sixth lens element is convex,
a periphery region of the light output surface of the sixth lens element is concave, and
lens elements of the optical lens assembly consist of the first lens element to the sixth lens element and satisfy following conditional expressions: EDmax/EDmin≤2.100 and 3.000≤(D21t32+G56)/D11t21, wherein EDmax is a maximum value of effective diameters of the first lens element to the sixth lens element, EDmin is a minimum value of the effective diameters of the first lens element to the sixth lens element, D21t32 is a distance from the light output surface of the second lens element to the light input surface of the third lens element, G56 is an air gap between the fifth lens element and the sixth lens element on the optical axis, and D11t21 is a distance from the light output surface of the first lens element to the light output surface of the second lens element.

2. The optical lens assembly according to claim 1, wherein the optical lens assembly further satisfies a following conditional expression: 12.500≤TTL/(G12+G34), wherein TTL is a distance on the optical axis from the light output surface of the first lens element to a light emitting surface of the multi-light source generating unit, G12 is an air gap between the first lens element and the second lens element on the optical axis, and G34 is an air gap between the third lens element and the fourth lens element on the optical axis.

3. The optical lens assembly according to claim 1, wherein the optical lens assembly further satisfies a following conditional expression: 9.200≤(EFL+T2+T3+T5+G56+T6)/(G34+G45), wherein EFL is an effective focal length of the optical lens assembly, T2 is a thickness of the second lens element on the optical axis, T3 is a thickness of the third lens element on the optical axis, T5 is a thickness of the fifth lens element on the optical axis, T6 is a thickness of the sixth lens element on the optical axis, G34 is an air gap between the third lens element and the fourth lens element on the optical axis, and G45 is an air gap between the fourth lens element and the fifth lens element on the optical axis.

4. The optical lens assembly according to claim 1, wherein the optical lens assembly further satisfies a following conditional expression: 13.800≤ALT/G34, wherein ALT is a sum of thicknesses of the sixth lens element from the first lens element to the sixth lens element on the optical axis, and G34 is an air gap between the third lens element and the fourth lens element on the optical axis.

5. The optical lens assembly according to claim 1, wherein the optical lens assembly further satisfies a following conditional expression: 6.500≤TL/(G34+G45), wherein TL is a distance from the light output surface of the first lens element to the light input surface of the sixth lens element on the optical axis, G34 is an air gap between the third lens element and the fourth lens element on the optical axis, and G45 is an air gap between the fourth lens element and the fifth lens element on the optical axis.

6. The optical lens assembly according to claim 1, wherein the optical lens assembly further satisfies a following conditional expression: 3.700≤(V2+V3)/V4, wherein V2 is an Abbe number Vd of the second lens element, V3 is an Abbe number Vd of the third lens element, and V4 is an Abbe number Vd of the fourth lens element.

7. The optical lens assembly according to claim 1, wherein the optical lens assembly further satisfies a following conditional expression: 2.900≤(V2+V3+V5)/(V1+V4), wherein V1 is an Abbe number Vd of the first lens element, V2 is an Abbe number Vd of the second lens element, V3 is an Abbe number Vd of the third lens element, V4 is an Abbe number Vd of the fourth lens element, and V5 is an Abbe number Vd of the fifth lens element.

8. An optical lens assembly, adapted to a projection lens element, wherein a plurality of light emitted by a multi-light source generating unit passes through the optical lens assembly to generate a plurality of light beams, a direction towards the multi-light source generating unit is a light input side, an opposite side of the light input side is a light output side, the optical lens assembly comprises a first lens element, a second lens element, a third lens element, a fourth lens element, a fifth lens element, and a sixth lens element sequentially from the light output side to the light input side along an optical axis, and each of the first lens element, the second lens element, the third lens element, the fourth lens element, the fifth lens element, and the sixth lens element comprises a light output surface facing the light output side and a light input surface facing the light input side,
wherein
the fifth lens element has positive refracting power,
an optical axis region of the light output surface of the second lens element is convex;
an optical axis region of the light input surface of the sixth lens element is concave,
a periphery region of the light output surface of the sixth lens element is concave, and
lens elements of the optical lens assembly consist of the first lens element to the sixth lens element and satisfy following conditional expressions: EDmax/EDmin≤2.100 and 4.100≤(D21t32+G56)*Fno/(D11t21+G34), wherein EDmax is a maximum value of effective diameters of the first lens element to the sixth lens element, EDmin is a minimum value of the effective diameters of the first lens element to the sixth lens element, D21t32 is a distance from the light output surface of the second lens element to the light input surface of the third lens element, G56 is an air gap between the fifth lens element and the sixth lens element on the optical axis, Fno is an F-number, D11t21 a the distance from the light output surface of the first lens element to the light output surface of the second lens element, and G34 is an air gap between the third lens element and the fourth lens element on the optical axis.

9. The optical lens assembly according to claim 8, wherein the optical lens assembly further satisfies a following conditional expression: 4.000≤TTL/BFL, wherein TTL is a distance from the light output surface of the first lens element to a light emitting surface of the multi-light source generating unit on the optical axis, and BFL is a distance from the light input surface of the sixth lens element to the light emitting surface on the optical axis.

10. The optical lens assembly according to claim 8, wherein the optical lens assembly further satisfies a following conditional expression: 1.600≤(T2+T3+T4+T5)/BFL, wherein T2 is a thickness of the second lens element on the optical axis, T3 is a thickness of the third lens element on the optical axis, T4 is a thickness of the fourth lens element on the optical axis, T5 is a thickness of the fifth lens element on the optical axis, and BFL is a distance from the light input surface of the sixth lens element to a light emitting surface of the multi-light source generating unit on the optical axis.

11. The optical lens assembly according to claim 8, wherein the optical lens assembly further satisfies a following conditional expression: 3.000≤EFL/BFL, wherein EFL is an effective focal length of the optical lens assembly, and BFL is a distance from the light input surface of the sixth lens element to a light emitting surface of the multi-light source generating unit on the optical axis.

12. The optical lens assembly according to claim 8, wherein the optical lens assembly further satisfies a following conditional expression: 2.400≤(V2+V4)/V1, wherein V1 is an Abbe number Vd of the first lens element, V2 is an Abbe number Vd of the second lens element, and V4 is an Abbe number Vd of the fourth lens element.

13. The optical lens assembly according to claim 8, wherein the optical lens assembly further satisfies a following conditional expression: 36.900≤V2*V3/V1, wherein V1 is an Abbe number Vd of the first lens element, V2 is an Abbe number Vd of the second lens element, and V3 is an Abbe number Vd of the third lens element.

14. The optical lens assembly according to claim 8, wherein the optical lens assembly further satisfies a following conditional expression: 43.900 degrees≤HFOV*TTL/EFL, wherein HFOV is a half field of view of the optical lens assembly, TTL is a distance from the light output surface of the first lens element to a light emitting surface of the multi-light source generating unit on the optical axis, and EFL is an effective focal length of the optical lens assembly.

15. An optical lens assembly, adapted to a projection lens element, wherein a plurality of light emitted by a multi-light source generating unit passes through the optical lens assembly to generate a plurality of light beams, a direction towards the multi-light source generating unit is a light input side, an opposite side of the light input side is a light output side, the optical lens assembly comprises a first lens element, a second lens element, a third lens element, a fourth lens element, a fifth lens element, and a sixth lens element sequentially from the light output side to the light input side along an optical axis, and each of the first lens element, the second lens element, the third lens element, the fourth lens element, the fifth lens element, and the sixth lens element comprises a light output surface facing the light output side and a light input surface facing the light input side,
wherein
the fifth lens element has positive refracting power,
a periphery region of the light output surface of the fifth lens element is concave;
an optical axis region of the light input surface of the sixth lens element is concave,
a periphery region of the light output surface of the sixth lens element is concave, and
lens elements of the optical lens assembly consist of the first lens element to the sixth lens element and satisfy following conditional expressions: EDmax/EDmin≤2.100 and 4.100≤(D21t32+G56)*Fno/(D11t21+G34), wherein EDmax is a maximum value of effective diameters of the first lens element to the sixth lens element, EDmin is a minimum value of the effective diameters of the first lens element to the sixth lens element, D21t32 is a distance from the light output surface of the second lens element to the light input surface of the third lens element, G56 is an air gap between the fifth lens element and the sixth lens element on the optical axis, Fno is an F-number, D11t21 is a distance from the light output surface of the first lens element to the light output surface of the second lens element, and G34 is an air gap between the third lens element and the fourth lens element on the optical axis.

16. The optical lens assembly according to claim 15, wherein the optical lens assembly further satisfies a following conditional expression: 5.100≤ALT/T1, wherein ALT is a sum of thicknesses of the six lens elements from the first lens element to the sixth lens element on the optical axis, and T1 is the thickness of the first lens element on the optical axis.

17. The optical lens assembly according to claim 15, wherein the optical lens assembly further satisfies a following conditional expression: 5.700≤(T2+T3+G56)/G12, wherein T2 is a thickness of the second lens element on the optical axis, T3 is a thickness of the third lens element on the optical axis, and G12 is an air gap between the first lens element and the second lens element on the optical axis.

18. The optical lens assembly according to claim 15, wherein the optical lens assembly further satisfies a following conditional expression: 6.100≤TTL/(G45+T5), wherein TTL is a distance from the light output surface of the first lens element to a light emitting surface of the multi-light source generating unit on the optical axis, G45 is an air gap between the fourth lens element and the fifth lens element on the optical axis, and T5 is a thickness of the fifth lens element on the optical axis.

19. The optical lens assembly according to claim 15, wherein the optical lens assembly further satisfies a following conditional expression: 2.300≤(T2+T3+G56)/(T4+G45), wherein T2 is a thickness of the second lens element on the optical axis, T3 is a thickness of the third lens element on the optical axis, T4 is a thickness of the fourth lens element on the optical axis, and G45 is an air gap between the fourth lens element and the fifth lens element on the optical axis.

20. The optical lens assembly according to claim 15, wherein the optical lens assembly further satisfies a following conditional expression: 3.600≤(T2+T3)/G12, wherein T2 is a thickness of the second lens element on the optical axis, T3 is a thickness of the third lens element on the optical axis, and G12 is an air gap between the first lens element and the second lens element on the optical axis.
